(19) United States
(12) Patent Application Publication
(10) Pub. No.: US 2011/0212761 A1
(43) Pub. Date: Sep. 1, 2011

(54) GAMING MACHINE PROCESSOR

(75) Inventors: Craig A. Paulsen, Reno, NV (US); Eric F. Taylor, Carson City, NV (US)

(73) Assignee: IGT

(21) Appl. No.: 12/714,405

(22) Filed: Feb. 26, 2010

(51) Int. Cl. A63F 13/00; G06T 15/00

(52) U.S. Cl. 463/25; 345/522

(57) ABSTRACT

A wager gaming machine includes a graphics processing unit (“GPU”) configured to perform graphics processing tasks to control a display system. The machine also includes a central processing unit (“CPU”) comprising at least one central processor and configured to control the wager gaming machine to provide at least one wagering game, make a delegation determination regarding when to delegate a non-graphics processing task to the GPU, and send delegation instructions to the GPU after making the delegation determination, wherein the GPU is further configured to receive delegation instructions from the CPU and to perform the non-graphics processing task according to the delegation instructions. The non-graphics task may be, for example, a communication task, a security task, or a compute-intensive task.

### BACKGROUND

The present application relates generally to computer-implemented gaming machines, and more specifically to use of multiple heterogeneous processors in gaming machines.

Computer implemented gaming systems can include wager-based games of chance, such as slots, blackjack, poker, roulette, and other games. These gaming systems use computers based on industry-standard components such as a central processing unit (CPU) interfaced to a motherboard that provides power, main memory, and input/output interfaces for the CPU. The CPU may be, for example, an AMD Turion™ processor, an Intel® Core™ processor, or the like. The motherboard has a standardized bus interface, e.g., the PCI™ standard, the PCI Express® standard, or the like, for interfacing removable components such as video display cards to the CPU. Gaming systems have numerous features such as graphics, security, and network communication that consume CPU processing resources. As more features and capabilities are added to the gaming systems, the CPU becomes more heavily loaded, and eventually the CPU may become fully utilized, at which point adding additional features becomes difficult, and a CPU upgrade may be needed. However, a CPU upgrade may introduce additional heat into the gaming machine, leading to a need for additional cooling devices such as fans, and potentially additional electricity demands for the fans and upgraded CPU.

A video display card can have a graphics processing unit (GPU) for performing graphics-related computations, and video memory that the GPU uses, for example, when rendering graphics images to be displayed on a video monitor. The GPU's processing architecture and instruction set are ordinarily different from those of the CPU, so program code (i.e., instructions) for the CPU are not compatible with the GPU, and vice versa.

### SUMMARY

Some wager gaming machines described herein include a graphics processing unit, often referred to as a “GPU,” that is used for graphics-related processing tasks such as drawing polygons and three-dimensional objects. In aspects of the invention, a central processing unit (“CPU”) in a gaming machine performs non-graphics tasks such as computing wagering game outcomes, and delegates selected non-graphics tasks to the GPU. The non-graphics tasks may be, for example, communication tasks, security tasks, compute-intensive, tasks, and the like.

In general, in a first aspect, the invention features a wager gaming machine that includes a value input system configured to receive indicia of credit, a payout system configured to dispense indicia of credit, a user input system configured to receive user input, an interface system comprising at least one network interface, a display system comprising at least one display device, a graphics processing unit (“GPU”), configured to perform graphics processing tasks to control, at least in part, the display system, a central processing unit (“CPU”) comprising at least one central processor, the CPU configured to do the following: control the wager gaming machine to provide at least one wagering game, make a delegation determination regarding when to delegate a non-graphics processing task to the GPU, and send delegation instructions to the GPU after making the delegation determination, where the GPU is further configured to receive the delegation instructions from the CPU and to perform the non-graphics processing task according to the delegation instructions.

Embodiments of the invention may include one or more of the following features. The CPU can be further configured to make the delegation determination by comparing a CPU load average to a GPU load average, and to determine that the delegation instructions are to be sent to the GPU if the GPU load average is less than the CPU load average. The CPU can be further configured to make the delegation determination when a thread of code is to be selected for execution by an operating system, and the delegation determination is made by the operating system based upon tasks available to run, tasks running on the CPU and GPU, and at least one attribute of the non-graphics processing task. The CPU can be further configured to determine that the delegation instructions are to be sent to the GPU when the non-graphics processing task is a compute-intensive task.

The delegation instructions may include instructions to load GPU-compatible code for the non-graphics processing task into the GPU, cause the GPU to execute the GPU-compatible code for the non-graphics processing task, receive a result of the non-graphics processing task, and provide the result to the CPU. The non-graphics processing task may include a communication task, a security related task, a compute-intensive task, or a combination thereof. The communication task may include receiving data via the interface system, parsing the data, forming a data structure according to the parsing step, and sending the data structure to the CPU. The communication task may include receiving data from the CPU, constructing a formatted message according to the data received from the CPU, and transmitting the formatted message via the interface system. The communication task may include receiving data via the interface system, decrypting the data, and sending decrypted data to the CPU. The communication task may include receiving data from the CPU, encrypting the data, and transmitting encrypted data via the interface system. The security related task may include an authentication task.

The non-graphics processing task may include receiving metering data from at least one of the value input system, the payout system, or the user input system, and transmitting, via the interface system, the metering data. The CPU may be further configured to provide the delegation instructions to the GPU via a common memory accessible by both the GPU and the CPU, the delegation instructions including: accessing gaming machine instructions from the CPU's memory, determining if the gaming machine instructions have been altered, and providing the result of determining if the gaming machine instructions have been altered to the CPU, where the CPU is further configured to halt, suspend, or restart the wagering game when the gaming machine instructions have been altered.

Determining if the gaming machine instructions have been altered may include determining a present digital signature based upon the gaming machine instructions, and comparing the present digital signature to a predetermined digital signature that is based upon predetermined gaming machine instructions, where the CPU is further configured to restart or halt the wager gaming machine when the present digital signature does not match the predetermined digital signature. The gaming machine instructions can be received from an executable code image associated with an operating system process. The common memory may be the CPU's main memory. The CPU may be further configured to do the following: access the delegation instructions via a common memory accessible by both the GPU and the CPU, determine if the delegation instructions have been altered, and restart or halt the wager gaming machine when the delegation instructions have been altered. The CPU can be further configured to determine a present digital signature based upon the delegation instructions, and compare the present digital signature to a predetermined digital signature, where the CPU is further configured to restart or halt the wager gaming machine when the present digital signature does not match the predetermined digital signature. The security related task can include monitoring access to the wager gaming machine. In some embodiments, the data structure can be processed more efficiently by the CPU than the data received via the interface system. The data received via the interface system can be represented in Extensible Markup Language (“XML”) format or in Game to System (“G2S”) format. The wager gaming machine can further include a removable graphics card on which the GPU is located and/or a main processor board on which the GPU and the CPU are located.

In general, in a second aspect, the invention features a wager gaming machine that includes a value input system configured to receive indicia of credit, a payout system configured dispense indicia of credit, a user input system configured receive user input, an interface system comprising at least one network interface, a display system comprising at least one display device, a graphics processing unit (“GPU”) configured to perform graphics processing tasks to control, at least in part, the display system, a central processing unit (“CPU”) comprising at least one central processor, the CPU configured to control the wager gaming machine in accordance with the gaming machine instructions to provide at least one wagering game, where the GPU is configured to receive the delegation instructions from a memory device associated with the GPU, the delegation instructions including accessing gaming machine instructions from the CPU's memory, determining if the gaming machine instructions have been altered, and halting, suspending, or restarting the gaming machine when the gaming machine instructions have been altered.

Embodiments of the invention may include one or more of the following features. Determining if the gaming machine instructions have been altered can include determining a present digital signature based upon the gaming machine instructions, and comparing the present digital signature to a predetermined digital signature that is based upon predetermined gaming machine instructions, where the GPU is configured to halt, suspend, or restart the wager gaming machine when the present digital signature does not match the predetermined digital signature. The memory device associated with the GPU can include a read-only memory. The CPU can be further configured to make a delegation determination regarding when to delegate a non-graphics processing task to the GPU, and send delegation instructions to the GPU after making a corresponding delegation determination, where the GPU is further configured to receive delegation instructions from the CPU and to perform the non-graphics processing task according to the delegation instructions. The wager gaming machine can further include a removable graphics card on which the GPU is located, and/or a main processor board, on which the CPU and GPU are located.

In general, in a third aspect, the invention features a non-transitory computer-readable medium having stored thereon stored instructions that, when executed by a central processing unit (“CPU”) of a gaming machine, direct the CPU to determine whether to delegate a non-graphics processing task to a graphics processing unit (“GPU”), where the GPU is separate from the CPU, and send delegation instructions to the GPU in response to determining that the non-graphics processing task is to be delegated to the GPU, where the delegation instructions include instructions for performing the non-graphics processing task, and the GPU is configured to receive the delegation instructions from the CPU and to perform the non-graphics processing task according to the delegation instructions.

Embodiments of the invention may include one or more of the following features. The stored instructions to determine whether to delegate a non-graphics processing task to a GPU can further direct the CPU to compare a CPU load measurement to a GPU load measurement, and determine that the delegation instructions are to be sent to the GPU if the GPU load measurement is less than the CPU load measurement. The stored instructions to determine whether to delegate a non-graphics processing task to a GPU can further direct the CPU to select a next task to execute based upon tasks available to run, tasks running on the CPU and GPU, and at least one attribute of the non-graphics processing task. The stored instructions to determine whether to delegate a non-graphics processing task to a GPU can further direct the CPU to determine that the delegation instructions are to be sent to the GPU when the non-graphics processing task is a compute-intensive task. The delegation instructions, when executed by the GPU, can direct the GPU to load GPU-compatible code for the non-graphics processing task into the GPU, cause the GPU to execute the GPU-compatible code for the non-graphics processing task, receive a result of the non-graphics processing task, and provide the result to the CPU. The non-graphics processing task can include a communication task, a security related task, a compute-intensive task, or a combination of those.

The CPU may be further configured to provide the delegation instructions to the GPU via a common memory accessible by both the GPU and the CPU, and the delegation instructions, when executed by the GPU, may direct the GPU to access gaming machine instructions from the CPU's memory, determine if the gaming machine instructions have been altered, and provide the result of determining if the gaming machine instructions have been altered to the CPU, where the CPU is further configured to halt, suspend, or restart the wagering game when the gaming machine instructions have been altered. The delegations, when executed by the GPU, may direct the GPU to determine a present digital signature based upon the gaming machine instructions, and compare the present digital signature to a predetermined digital signature that is based upon predetermined gaming machine instructions, where the stored instructions, when executed by the CPU, further direct the CPU to restart or halt the wager gaming machine when the present digital signature does not match the predetermined digital signature.

In general, in a fourth aspect, the invention features a non-transitory computer-readable medium having stored thereon instructions that, when executed by a central processing unit (“CPU””) of a gaming machine, direct the CPU to control the wager gaming machine to provide at least one wagering game, where the GPU is configured to receive the delegation instructions from a memory device associated with the GPU, the delegation instructions including: accessing gaming machine instructions from the CPU's memory, determining if the gaming machine instructions have been altered, and halting, suspending, or restarting the gaming machine when the gaming machine instructions have been altered.

Embodiments of the invention may include one or more of the following features. The computer readable medium can further include instructions stored thereon that when executed by the CPU, further direct the CPU to determine a present digital signature based upon the gaming machine instructions, and compare the present digital signature to a predetermined digital signature that is based upon predetermined gaming machine instructions, where the GPU is configured to halt, suspend, or restart the wager gaming machine when the present digital signature does not match the predetermined digital signature.

### BRIEF DESCRIPTION OF THE DRAWINGS

FIG. 1 illustrates components of a computer-implemented gaming machine in accordance with embodiments of the invention.

FIG. 2A illustrates multithreaded processes in a gaming application in accordance with embodiments of the invention.

FIG. 2B illustrates tasks in a single-threaded gaming application in accordance with embodiments of the invention.

FIG. 2C illustrates tasks in a multithreaded gaming application in accordance with embodiments of the invention.

FIG. 3 is a flow diagram illustrating a process for dispatching tasks to heterogeneous processors in accordance with embodiments of the invention.

FIG. 4A is a flow diagram illustrating a scheduler process in accordance with embodiments of the invention.

FIG. 4B is a flow diagram illustrating a dispatcher process in accordance with embodiments of the invention.

FIG. 5 is a flow diagram illustrating a process of authenticating game code in accordance with embodiments of the invention.

FIG. 6 illustrates an electronic gaming machine in accordance with embodiments of the invention.

FIG. 7 illustrates a network in accordance with embodiments of the invention.

FIG. 8 is a block diagram illustrating a communication topology in accordance with embodiments of the invention.

FIG. 9 illustrates a network device in accordance with embodiments of the invention

### DETAILED DESCRIPTION

While the present invention will be described with reference to a few specific embodiments, the description is illustrative of the invention and is not to be construed as limiting the invention. Various modifications to the present invention can be made to the preferred embodiments without departing from the true spirit and scope of the invention as defined by the appended claims. For example, the steps of methods shown and described herein are not necessarily performed in the order indicated. It should also be understood that the methods of the invention may include more or fewer steps than are indicated.

Device functionality may be apportioned by grouping or dividing tasks in any convenient fashion. Therefore, when steps are described herein as being performed by a single device (e.g., a single printer, gaming machine, handheld device or server), the steps may alternatively be performed by multiple devices and vice versa.

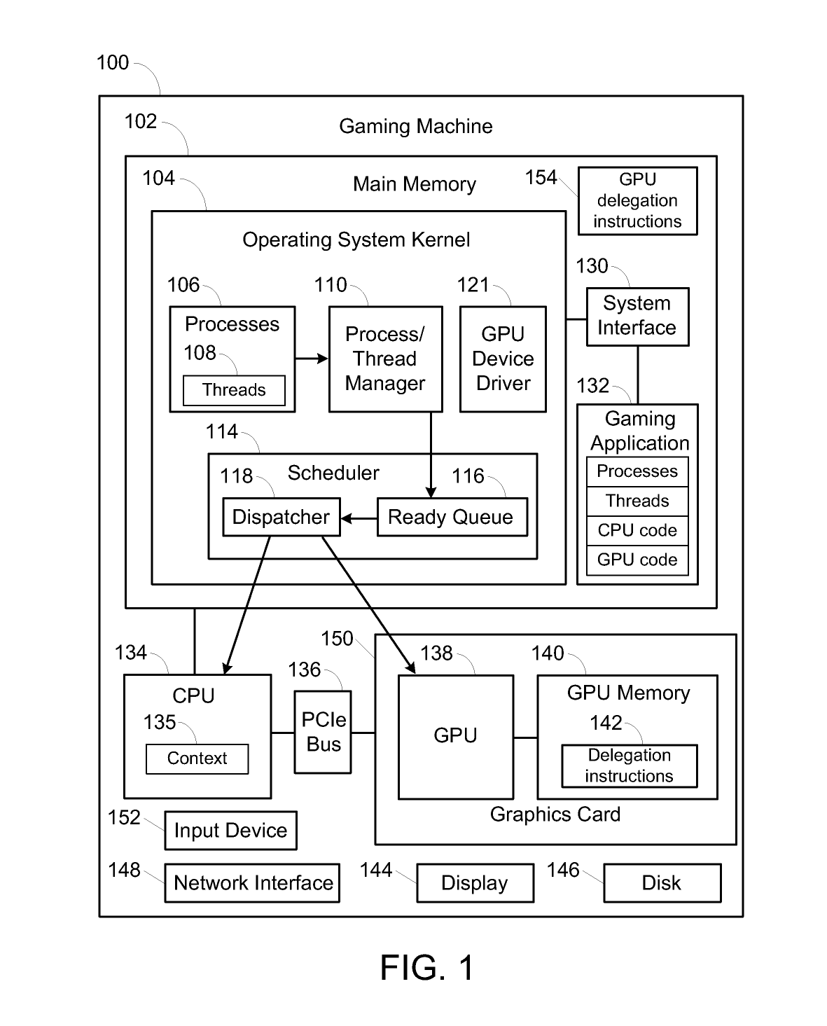

FIG. 1 illustrates components of a computer-implemented gaming machine in accordance with embodiments of the invention. A gaming machine 100 implements a wager-based game of chance using a display device 144 to display graphical representations of game states, and input device 152 to receive input from a user, such as game parameters, value input and output devices for receiving and generating indicia of value, e.g., payment vouchers or cards, a CPU 134 for executing a gaming application 132 that implements the rules of the game, player interactions, and the like, and the main memory 102 into which the gaming application 132 can be loaded from a storage device such as, for example, a disk 146, a network interface 148, a ROM (not shown) or other storage systems. The network interface 148 provides for communication between a gaming machine 100 remote computers, servers, gaming machines, and the like via a computer network such as an Ethernet, IEEE 802.11, and so on. In one example, the CPU 134, main memory 102, PCI Express bus 136, and other input/output interfaces, such as Universal Serial Bus interfaces (not shown), are components attached to a motherboard (not shown), and may implement a master gaming controller in the gaming machine 100.

In one example, the CPU 134 executes an operating system kernel 104 that can be loaded from a storage device as described above with reference to the gaming application 132. The operating system kernel 104 in combination with a user level system interface 130, e.g., an application programming interface, provides an interface between the CPU 134, and other devices of the gaming machine 100 and applications to simplify the task of implementing applications such as the gaming application 132. The operating system 104 may be, for example, the QNX™, Linux®, UNIX®, VxWorks®, or Microsoft Windows® operating system, and the CPU 134 may be, for example, the AMD Turion™ or Intel Core™ processor. The operating system 104 provides programming abstractions such as processes 106 that correspond to programs being executed by the CPU 134. Each process is an instance of the program such as the gaming application 132. A process may include one or more threads, where each thread represents a path of execution within the process. Each process has a process context, which is loaded a CPU context 135 (e.g., internal CPU state such as register values) when the thread is executing on the CPU.

The threads share most of the process's context, but have their own execution paths (i.e., program counters), numeric thread identifiers, and other thread-specific information such as a thread local storage (TLS) data structure. Use of multiple threads within a single application enables the application to take advantage of multiple processors, but ordinarily involves structuring the application so that tasks that can occur simultaneously are executed in different threads. Implementing an application as multiple processes is also possible, but sharing application data across processes is ordinarily less efficient than sharing data across threads. The threads may run simultaneously if multiple CPU's are available, with one thread executing on each CPU at a given time. If one CPU is available, or there are fewer CPU's than threads, the threads share the CPU(s) using time slicing.

A process can be represented by a process control block (PCB), which is a data structure that includes information about the process, such as the process's context, i.e., the state of internal CPU registers and program memory during execution of the process, and a numeric process identifier that identifies the process. Similarly, a thread is represented by a thread control block (TCB) that includes thread context information specific to the thread, such as thread-local storage.

Because of the similarities between processes and threads, with threads having smaller contexts and faster context switch times, the following description of CPU scheduling applies at either the process level or at the thread level, and the term “process” in the following description means “process or thread.” The CPU 134 is capable of executing one (or a small number) of processes or threads at a time, and may switch between different processes or threads by switching contexts between the CPU's internal registers and main memory 102, in which contexts of other processes or threads are stored, so that multiple processes or threads can share the CPU. A scheduler 114 determines when and for how long each process will execute on the CPU 134. Thus each process can be in one of several possible states, such as executing on the CPU or waiting to be executed on the CPU. While a process is waiting, its context is stored in the main memory 102, and in a process control block

A process manager 110 creates processes and threads in response to requests from the application 132 or the operating system 104. To create a new process or thread, the manager 110 creates a PCB or TCB, respectively, and adds the new PCB or TCB to a ready queue 116. A scheduler 114 selects PCB's or TCB's from the ready queue 116 according to a scheduling algorithm that uses the priorities to determine which process or thread from the ready queue to execute next. Many such scheduling algorithms are known to those skilled in the art. A priority value may be associated with each process or thread, and the scheduling algorithm may select the process or thread having the highest priority. Processes or threads with higher priority values may be executed by the CPU 134 before processes or threads with lower priority values. Ties between processes or threads of the same priority may be resolved by selecting the process or thread that was added to the ready queue 116 first. The scheduler 114 passes the selected PCB or TCB to a dispatcher 118, which performs a context switch by causing the context currently in the CPU context 135 to be saved in the main memory 104, and the context of the process or thread identified by the PCB or TCB to be loaded into the CPU context 135. The scheduler 114 determines the time at which the context switch will occur based on the scheduling algorithm and the state of the process currently executing on the CPU. For example, if the current process or thread performs an input/output operation, or waits for an interrupt event, or voluntarily yields the CPU, the scheduler responds by selecting a next process or thread to be executed by the CPU, and causing a dispatcher 118 to perform a context switch that replaces the current process or thread with the next process or thread. The scheduler may also cause the dispatcher to preempt the current process or thread if the process or thread has been running for at least a determined interval of time, which interval is referred to as a time slice. When a process or thread is preempted, it can be re-added to the ready queue 116 for subsequent continued execution. Details of task and process dispatching and scheduling method that may be used with embodiments of the present invention are described in the reference “Operating System Concepts” by A. Silberschatz, J. Peterson, and P. Galvin, Addison-Wesley, 1991, ISBN 0-201-51379-X, which is incorporated herein by reference for all purposes.

A gaming machine 100 can include a graphics card 150 for rendering and displaying 2- and 3-dimensional images on the display 144. The graphics card 150 includes a graphics processing unit (GPU) 138 and a GPU memory 140 accessible by the GPU 138. The graphics card 150 need not be present, however. If the graphics card 150 is omitted, the GPU 138 can be located on a motherboard (not shown) along with the CPU 134 and other components, e.g., as an “onboard” GPU integrated with the motherboard chipset. The CPU can cause delegation instructions 154, e.g., GPU program code instructions, to be loaded into the GPU, e.g., by transferring a GPU program from the main memory 102 to the GPU memory 140. The delegation instructions 154 can be copied to the GPU memory 140 to form delegation instructions 142. The CPU can send the delegation instruction 154 to the GPU to cause the GPU to execute the delegation instructions 142 to perform a task. The CPU can also cause any input data needed for the graphics computations to be transferred to the GPU memory 140. In some implementations, the GPU can use direct memory access to access the delegation instructions 154 in the CPU's main memory 102 directly via the bus 136, without the aforementioned data copy or transfer operation. The GPU can execute the delegation instructions 146 and/or 154 independently of the CPU, i.e., concurrently with the CPU's execution of CPU programs and can cause the results to be rendered on a video display.

The delegation instructions 154,142 are program code instructions executable by the GPU 138 that cause the GPU to perform a computational task. Although GPU's were originally designed for displaying graphics, such as 2-dimensional renderings of 3-dimensional images at high speed, GPU's can also execute non-graphical tasks such as compute-intensive tasks that perform computations on data received from the CPU and provide the results to the CPU. Examples of compute-intensive tasks include, for example, data transformations and mathematical calculations. A compute-intensive task is, in one example, a task that does not render graphical images, but instead performs other types of computations such as general-purpose calculations for controlling aspects of a wagering game other than the graphical display. In one aspect, a compute-intensive task does not access input/output devices of the gaming machine 100. That is, a compute-intensive task can receive input from the CPU 135 via the bus 136, and can send results to the CPU 124 via the bus 136, but does not receive input from or provide output to input/output devices such as the input device 152, the network device 148, the display 144, or the disk 146. Thus the delegation instructions are, in one example, program code instructions that when executed cause the GPU to perform a non-graphics task such as a compute-intensive task.

In one example, delegation instructions 154 that implement a desired non-graphics processing task can be loaded into the GPU 138, and the GPU can execute the non-graphics processing task in parallel with any graphics operations and other computations requested by the CPU 135. The parallel execution may be implemented using time-slicing to share the GPU between tasks. As will be described below, the results of a computational task can be accessed by the CPU via the bus 136 using a direct memory access of the GPU memory 140 and/or after a transfer of the results to the main memory 102.

The graphics card 150 communicates with the CPU 134 using the PCI Express bus 136 or similar high-speed bus. Although the GPU 138 is intended for use in rendering complex graphics images at high speeds using programming interfaces such as the OpenGL® graphics interface, the GPU also provides for execution of general-purpose computations specified by kernels of computer program code. The kernels may be implemented using the GPU's instructions set, or, more commonly, using a high-level language such as C, or a variant thereof, that is compiled to GPU instructions. For example, GPU's produced by Advanced Micro Devices Corp. (AMD) of Sunnyvale, Calif. can be programmed using the “Stream” interface, and GPU's produced by NVIDIA Corporation of Santa Clara, Calif. can be programmed using the “Cuda” interface. The ATI Stream interface is described in the document entitled “ATI Stream Computing—Technical Overview” dated Mar. 20, 2009 and published by AMD. Other interfaces may also be used, such as the industry-standard OpenCL interface. The GPU kernel code is loaded onto the graphics card 150 as GPU code 142, which is stored, for example, in the GPU memory 140. The GPU 138 performs a form of scheduling in which compute kernels share the GPU with graphics code, kernels are ordinarily relatively small portions of code that, for example, perform a computation on input data received from the main memory 102, and generate output data, which can be stored in the main memory 102. The interface between the main memory 102 and the GPU 138 may be different for different types of graphics card 150 and/or different graphics card vendors. In one embodiment, the GPU 138 does not access the main memory 102 directly, but instead relies on the CPU 134 to perform data transfers between the main memory 102 and the GPU memory 140 over the PCI express bus 136. In other examples, the GPU 138 can access the main memory 102 more directly, without the need for copying data between the main memory and the GPU memory.

Although the GPU is capable of executing general-purpose computations, in one embodiment the GPU communicates with the CPU by transferring data on the PCI Express bus 136, and can send image data to the display 144, but cannot communicate with other devices in the gaming machine 100, including input devices 152, network devices 148, and other peripherals. Therefore, in one example, the code to be executed by the GPU is a non-graphics processing task, as described above, which does not perform any input/output or other operations that use input/output devices, such as input/output devices external to the graphics card or motherboard. Each function of the application that performs computation with no input/output or other interaction with hardware devices beyond the graphics card can potentially be executed on the GPU. To execute an application function on the GPU, a data processing task that does not perform input or output should be identified and invoked in a thread separate from the main application thread. The data processing task should be implemented in a GPU-compatible language so that the GPU code can be compiled or assembled and loaded into the GPU. The separate thread allows the GPU task to benefit from multiprocessing, in which the GPU task is performed in parallel with CPU tasks, because the thread can be scheduled on the GPU to execute concurrently with other threads executing on the CPU. In one embodiment, the developer of the application 132 provides implementations of the task for both the CPU and the GPU, in which case the task can be scheduled to execute on either the CPU or the GPU, depending on the task priority and the availability of the CPU and GPU. In another embodiment, the developer may provide an implementation for the GPU only.

An example processing task is Game to System (G2S™) message creation and parsing, which involves substantial CPU time in existing gaming systems. A G2S parsing task can receive a G2S XML-format message as input and construct a data structure as output, which the CPU is able to process more efficiently than the original G2S XML message. Conversely, a G2S message creation task can receive a data structure as input and construct a G2S XML message as output. The input is passed or copied from the CPU memory to the GPU memory, the GPU performs the computation, and the result of the computation is passed or copied from the GPU memory to the CPU memory. Other types of tasks include, without limitation, constructing and parsing machine metering messages, encrypting and decrypting data, and the like. Further details about the G2S protocol and messages may be found in the document entitled “G2S™ MESSAGE PROTOCOL V1.0.3” published by the Gaming Standards Association G2S Technical Committee, Standard v1.0 adopted 2006 Dec. 15, released: 2007 Apr. 12, document ID: gsa-p0075.003.01, which is incorporated herein by reference in its entirety and for all purposes. Further details about machine meters may be found in U.S. patent application Ser. No. 11/796,589, entitled “TECHNIQUE FOR DISPLAYING GAMING MACHINE INFORMATION USING MACHINE READABLE DISPLAY MECHANISMS” and filed on Apr. 26, 2007 (attorney docket no. IGT1P262), which is incorporated herein by reference in its entirety and for all purposes.

Another example of a processing task is simulating a peripheral device during times that the peripheral device is offline by recording commands sent to the peripheral by the operating system and/or application and forwarding the recorded commands to the peripheral when the peripheral becomes available. In this example, the operating system provides a mechanism by which peripheral ownership is transferred between the CPU 134 and the GPU 138. For example, if a ticket printer is offline, a “print ticket” command, which has a relatively low priority, can be processed by the GPU 138 instead of the CPU 134 to optimize use of processor resources depending on system loads and demands. The GPU acts as a virtual device, e.g., a virtual ticket printer, thereby freeing up the CPU or a peripheral's processor to perform other operations or share computing resources with other machines. When the ticket printer becomes available, the GPU may initiate transfer of the stored commands to the ticket printer. If the GPU is unable to initiate communications with the ticket printer, e.g., because peripheral devices are not accessible to the GPU, then the CPU can cause the stored commands to be transferred to the printer, e.g., in response to an instruction stored in a common memory by the GPU.

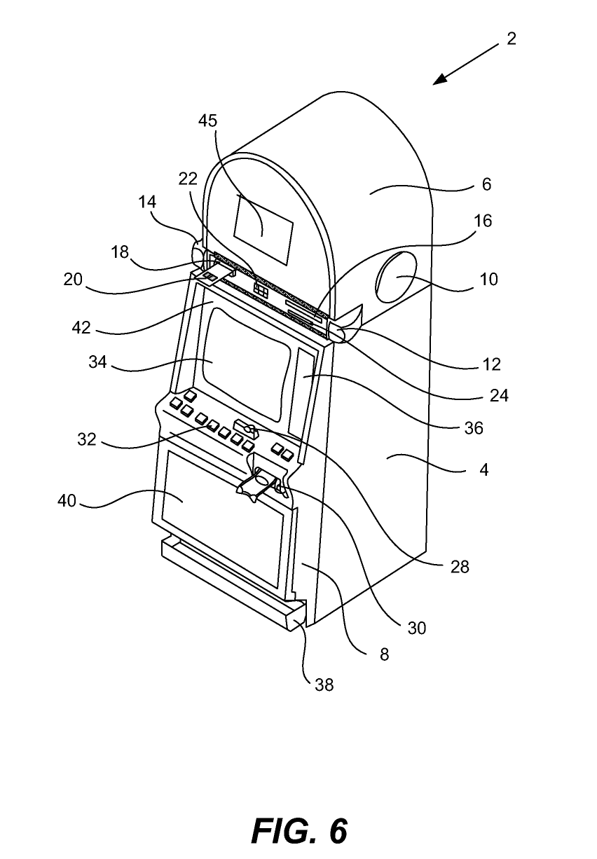

Another example of a processing task is security monitoring program code that detects intrusion into a gaming machine by monitoring security switches attached to access doors in the slot machine cabinet. As described elsewhere herein with reference to FIG. 6, access violations result in suspension of game play and can trigger additional security operations to preserve the current state of game play. Further details about monitoring the access doors may be found in U.S. Pat. No. 6,773,348 to Stockdale, entitled “BATTERY POWERED GAMING MACHINE SECURITY MONITORING SYSTEM” and filed on Oct. 9, 2001, which is incorporated herein by reference in its entirety and for all purposes. Such security monitoring can be performed at least in part by program code executed by the GPU 138. In one aspect, tasks suitable for execution by the GPU 138 include tasks which communicate with external devices but do not process money, e.g., do not award winnings or receive money or credit, and tasks for which the program code is unlikely to change over time, since the costs of implementing the program code and loading the program code into the GPU 138 are more likely to be outweighed by the benefit of reducing the load on the CPU 134 over longer periods of time.

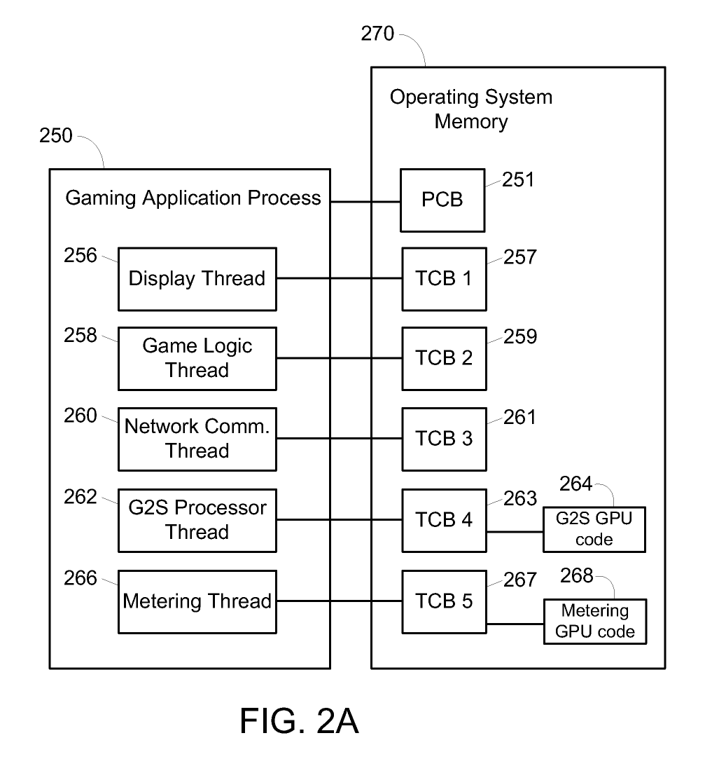

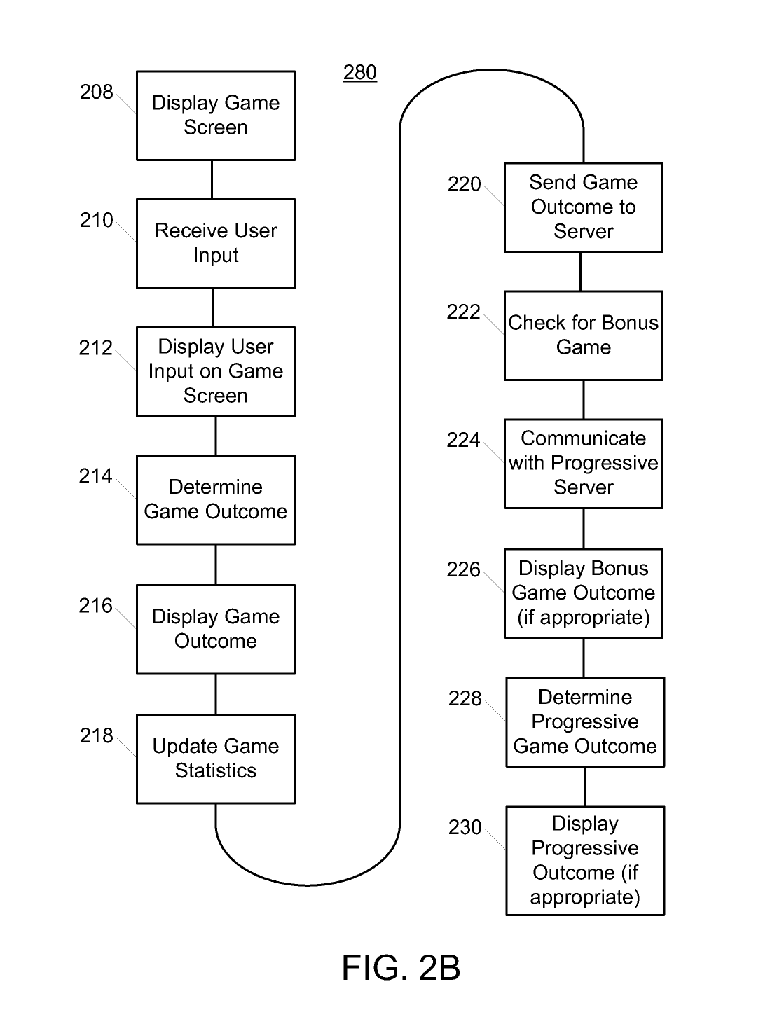

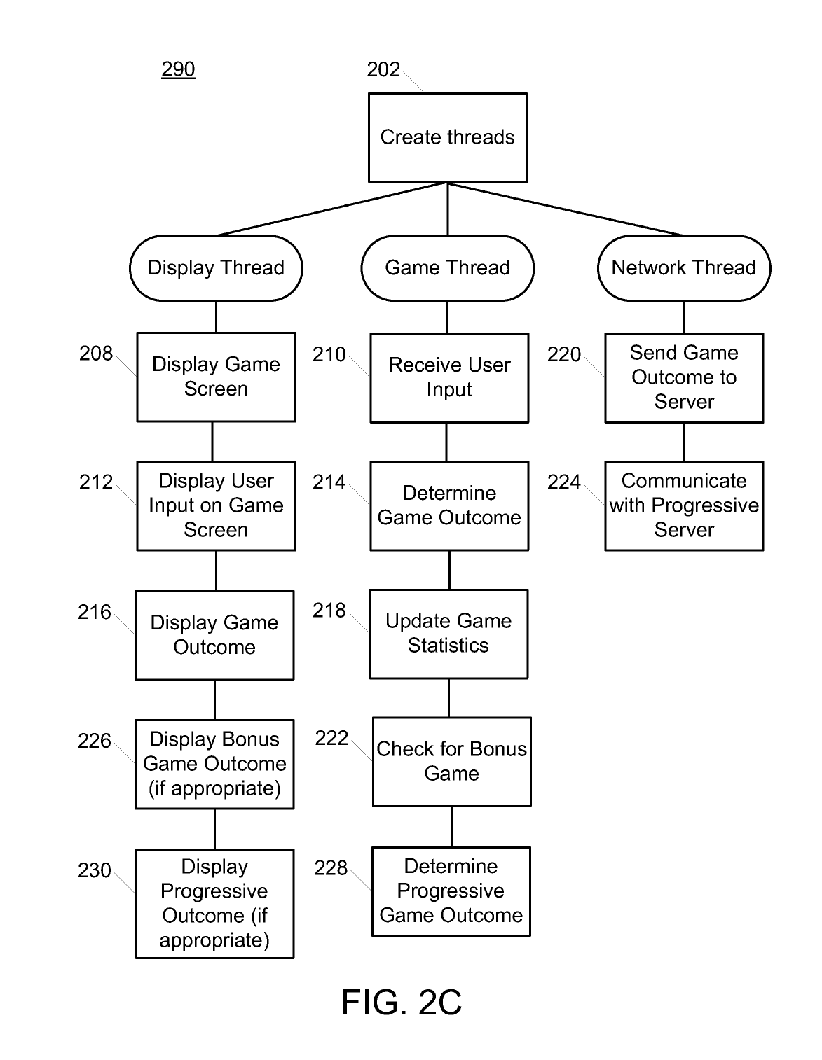

FIG. 2A illustrates a multithreaded process in a gaming application in accordance with embodiments of the invention. A gaming application process 250 is an executing instance of a gaming application and is structured as a set of threads that can execute concurrently, or at least appear to a user to execute concurrently using multithreading execution techniques for sharing the CPU. The gaming application may be, for example, the application 132 of FIG. 1. The gaming application creates several threads of execution, which all execute at various times in the gaming application process 250. The process 250 is represented by a Process Control Block (PCB) 251 in the operating system, and each of the threads is represented by a corresponding Thread Control Block (TCB) in the operating system. The PCB and TCB's are stored in operating system memory 270 created by the process/thread manager 110 and managed by the scheduler 114, which places PCB's and TCB's to be executed on the ready queue 116. In one example, a display thread 256 generates images to be displayed and animated while the application performs other tasks such as those described below. The display thread 256 is associated with a first TCB 257 that is used by the operating system kernel 104 to schedule the display thread 256 for execution on the CPU. In this example, no GPU code is associated with the display thread 256 and TCB 257, so the display thread 256 will execute on the CPU but not on the GPU.

The threads of the gaming application process 250 include a game logic thread 258, a network communication thread 260, a Game to System (G2S) processor thread 262, and a metering thread 266. The game logic thread 258 implements the game rules, receives user input, and instructs the display thread 256 to draw images appropriate for each point in the game. The game logic thread 258 is associated with a second TCB 259. The network communication threads 260 implements networking protocol operations, e.g., the G2S and HTTP protocols, and sends and receives data over the network on behalf of the gaming application 250. The network communication thread 260 is associated with a third TCB 261. The G2S processor thread 262 performs marshaling and un-marshaling (i.e., conversion) of G2S data to and from XML format on behalf of the network communication thread 260 and the game logic thread 258. Further details related to network protocol operations that may be used in the present invention are described in U.S. patent application Ser. No. 11/874,097, entitled “TOURNAMENT MANAGER FOR USE IN CASINO GAMING SYSTEM” and filed on filed Oct. 17, 2007 (attorney docket no. IGT1P401), which is incorporated herein in its entirety and for all purposes.

The G2S processor thread 262 is associated with a fourth TCB 263, which includes or references GPU code 264 for performing G2S processing operations on a GPU. The G2S thread can thus be executed on either the GPU or the CPU, since implementation code is provided for both processors. The metering thread 266 monitors devices in the game machine and transmits metering information to remote servers via the communication network with the assistance of the network communication thread 260 and the G2S processor thread 262. The metering thread 266 is associated with a fifth TCB 267, which includes or references GPU code 268 for analyzing the metering information. The GPU code 264, 268 may be stored in the operating system memory 270 as shown, or in the gaming application process's memory, in which case the code can be referenced by pointers from the operating system as needed.

FIG. 2B illustrates tasks in a single-threaded gaming application 280 in accordance with embodiments of the invention. The single-threaded game application 280 is implemented using tasks that execute in the sequence shown in FIG. 2B. Display animation continues in parallel with the tasks but does not necessarily use a separate thread. The animation may be performed by, for example, event handlers or code programmed into the GPU, but the tasks are not structured to operate in parallel in the example of FIG. 2B. The game application begins at a display task 208 by displaying an initial game screen. An input task 210 waits for and receives user input such as a wager amount and game start command. A display task 212 displays the user input, the game text, and the game graphics on a video display. A game outcome task 214 determines the game outcome based on, for example, the game input and a random value. A display outcome task 216 displays the game outcome. A game statistics update task 218 updates game statistics and jackpot information, and sends the updated statistics and information to the display task. An outcome communication task 220 sends the outcome to a server. A bonus game task 222 checks for bonus game eligibility and determines the bonus game outcome. A communication task 224 communicates with a progressive server. The communication tasks 220 and 224 perform G2S processing as part of the network communication. A bonus game display task 226 displays the bonus game outcome if a bonus game occurred. A progressive task 228 determines a progressive game outcome based on information received in block 224, and a progressive outcome display task 230 displays the progressive game outcome.

FIG. 2C illustrates tasks in a multithreaded gaming application 290 in accordance with embodiments of the invention. The multithreaded game application 290 begins at start block 202, where threads are created, including a display thread, the game logic thread, a networking communication thread, and metering thread (not shown). The tasks in each thread execute sequentially, but tasks in different threads can execute simultaneously if the two different threads are allocated to different processors (e.g., the CPU and GPU). In the example of FIG. 2C, the display thread tasks may execute simultaneously with the game logic tasks, or with the networking communication tasks, or with the metering tasks. If more than two processors are available, then a thread can execute on each processor. Therefore, if the total number of CPU's and GPU's in the gaming machine is equal to the number of threads, then all threads can execute simultaneously. There may be interaction between the different threads, e.g., to send input data such as graphics display commands, or to receive output data such as a game outcome between two threads, in which case only one of the communicating threads will execute until the interaction is complete. Communication between threads can be implemented using data structures in the process address space, such as variables or queues, and corresponding synchronization operations to coordinate access to the shared data structures. Therefore, data structures used for communication between different threads are accessed serially, i.e., accesses to a data structure by different threads are synchronized so that no more than one thread modifies or reads a shared data structure at a time. Threads may wait for other threads to provide information, and may signal other threads that information is ready using wait/notify operations or the like, as known to those skilled in the art.

Referring to FIG. 2C, the display thread executes the initial game screen task 208, the display user input task 212, the display game outcome task 216, the bonus game display task 226, and the progressive outcome display task 230. The display tasks receive information and commands from the game logic task via, for example, a shared variable, as described above. The game logic thread executes the user input task 210, the game outcome task 214, the game statistics update task 218, the bonus game task 222, and the progressive outcome determination task 228. The network communication task executes the outcome communication task 220 and the progressive server communication task 224. The metering thread (not shown) executes a metering task concurrently with the tasks in the other threads. When multiple processors are available, a multithreaded game application such as that shown in FIG. 2C will execute faster than a single-threaded version of the same application, at least to the extent that the threads executing on different processors are independent of each other, i.e., the threads are not waiting for other threads to produce results. The gaming application thread structure shown in FIG. 2C is just one example of a possible threading structure. Other arrangements of threads and tasks are possible and may be more efficient than the arrangement shown, but such other arrangements can be produced using the concepts described above.

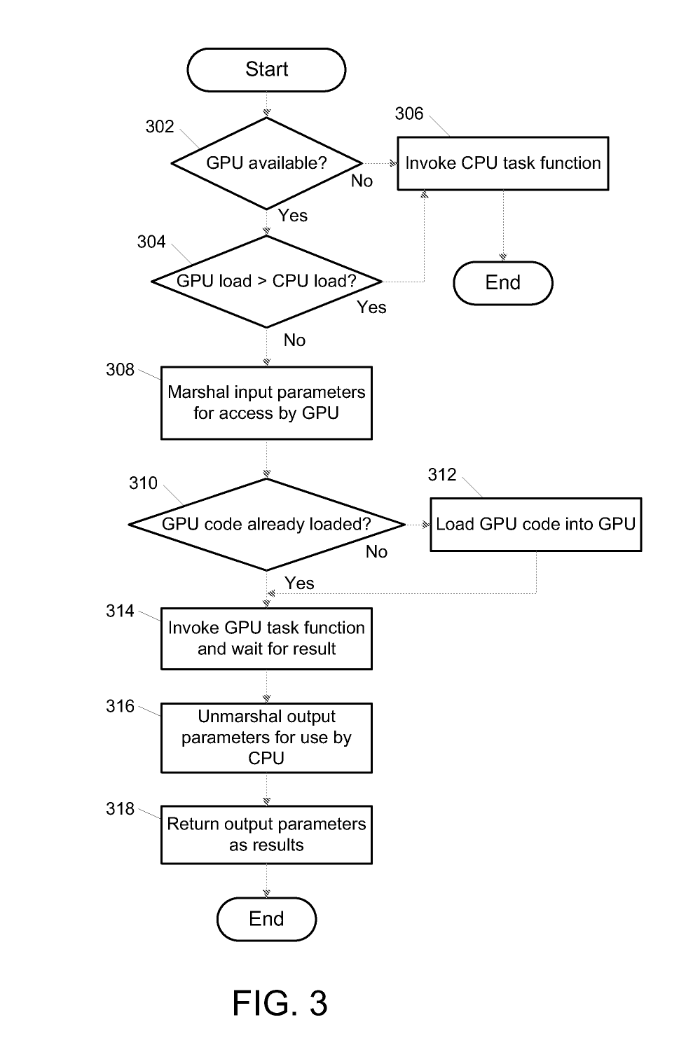

FIG. 3 is a flow diagram illustrating a process for dispatching tasks to heterogeneous processors in accordance with embodiments of the invention. The process of FIG. 3 may be embedded in and invoked by a user-level gaming application 132 to execute tasks on the GPU in parallel with execution of other tasks on the CPU. No operating system modifications are needed in the example of FIG. 3, since the dispatching process can be invoked from a user process or thread. Using the process of FIG. 3, an application developer can access the GPU through a GPU device driver 121 (shown in FIG. 1) and GPU programming interface (e.g., ATI Stream, NVIDIA Cuda, or OpenCL). The dispatcher process of FIG. 3 runs in a thread that is scheduled by the operating system and can be assigned a priority value by the application developer. The dispatcher process invokes the GPU and waits for the GPU result, so the priority of the GPU computation can be effectively set by setting the priority of the dispatcher thread's process. Since the process waits for the GPU result, the operating system scheduler can run another thread on the CPU while the GPU is performing the computation.

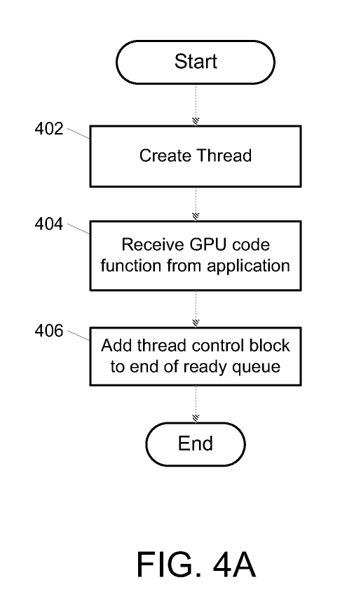

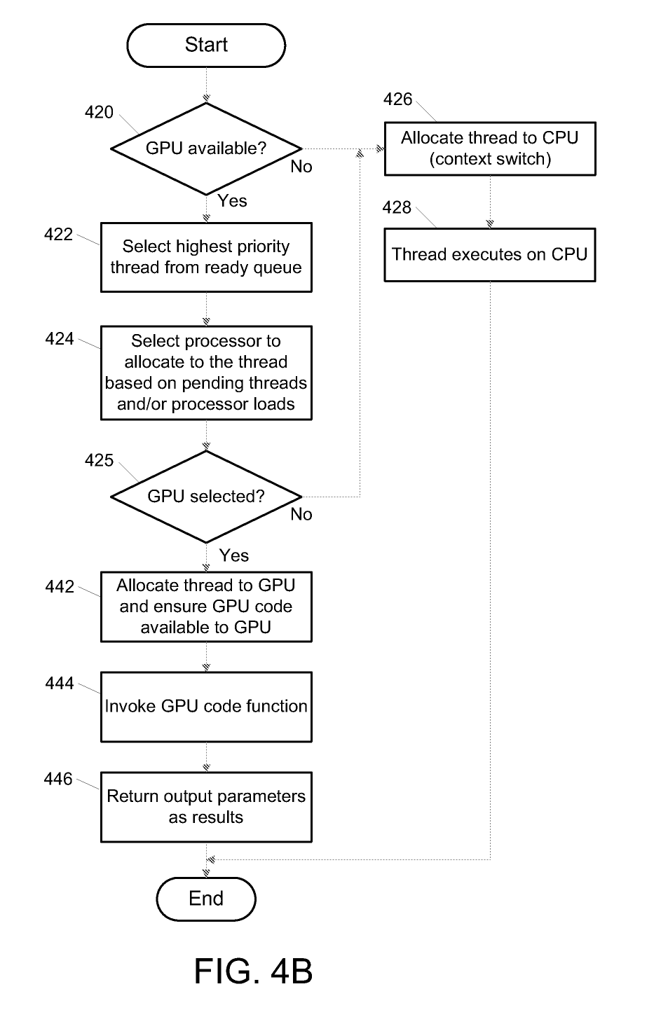

Although the dispatcher process of FIG. 3 can select either the CPU or the GPU when executing a task, in this example the selection performed by the dispatcher process is not based on information available inside the operating system, such as the set of threads ready and waiting to run and their priorities and task types (i.e., CPU or GPU tasks). Instead, the dispatcher process of FIG. 3 uses load measurements such as the current respective loads or load averages (e.g., utilization percentages) of the CPU and GPU to determine whether to execute the task on the CPU or on the GPU. The term “load” may be understood as a measure of the amount of work performed by the CPU and/or GPU. The term “load average” refers to an average load over a period of time, such as 1 minute, 3 minutes, 5 minutes, and the like. Another solution, which provides for use of the priorities of the ready threads, is to modify the operating system's scheduler to dispatch GPU-compatible threads, in which case the CPU or GPU can be selected based on the system scheduler's queue of threads ready to be run, and also, in one example, based upon the loads or load averages of the CPU and GPU. This alternate solution is described below with respect to FIGS. 4A and 4B.

Referring again to FIG. 3, the illustrated dispatcher process executes a given set of CPU computer program instructions on the CPU, or analogous GPU computer program instructions on the GPU, depending on the loads of the CPU and GPU and the priority of the thread from which the dispatcher process is invoked. This process may be included in a program interface library and provided to application developers with a name such as Execute Computation. The CPU and GPU versions of the program instructions for the computation are supplied to this process as input, and the application developer is expected to create the programs for both the CPU and GPU in this example. The dispatcher process begins at block 302 by determining if the GPU is available. In one example, the GPU is available if it is ready to execute tasks. If the GPU is not available, the CPU version of the task is invoked at block 306 and the process subsequently exits. The respective utilization loads of the GPU and CPU may also be used to decide whether to allocate a task to the GPU or CPU. For example, if the recent load average of the GPU is less than a threshold value or less than the load average of the CPU, then the task can be allocated to the GPU even if the GPU load is not zero. Therefore, in one example, if the GPU is available, block 304 determines whether the task should be executed on the GPU or the CPU by comparing the current utilization loads of the two processors. In one example, a utilization load of 0 indicates that a processor is executing no (or very few) instructions, and a load of 1.0 indicates that the processor is fully utilized, i.e., is executing instructions and has been for some defined period of time, such as a predetermined number of seconds. In other examples, different measures of processor load may be used. Block 304 allocates the task to the processor that has the lowest utilization load. That is, if the CPU load is greater than the GPU load, then the task is allocated to the GPU, and vice versa. If the CPU has the lowest load, then the task is executed on the CPU at block 306 by, for example, invoking the program code (i.e., function) that implements the CPU version of the task. Any input values that are provided as parameters to the dispatcher process, e.g., as parameters to the ExecuteComputation function in the game application, are passed to the CPU program function. In another example, attributes of the task may be used in the determination of whether to execute the task on the GPU or on the CPU. The task may have an attribute that specifies the type of the task, e.g., numeric computation, input/output, graphics display, game logic, and the like.

Certain types of tasks may be better suited to the GPU, such as compute intensive tasks. Compute-intensive tasks may be, for example, tasks that do not access input or output devices, and/or do not access other system resources that are not accessible to code executing on the GPU. Such GPU-suited tasks may be assigned to the GPU if the GPU's load average is below a certain threshold or if the task has a low priority. If block 304 determines that the GPU has the lowest load or is better suited to execute the task than is the CPU, then the dispatcher continues at block 308, which makes the input parameters available to the GPU, e.g., in a shared memory or by copying the parameter values from main memory to GPU memory. Block 310 determines if the GPU version of the task has previously been loaded into the GPU (e.g., by a previous invocation of the dispatcher process). If not, block 312 loads the GPU code for the task into the GPU using the appropriate GPU interface function. Block 314 invokes the GPU function code and waits for the result. The wait operation may yield the CPU to another thread, or, if not, a thread yield function can be explicitly invoked at block 314. The CPU then proceeds to execute the next ready thread, which can run concurrently with the GPU task. When the GPU task completes its computation, block 316 makes the task function's output parameters available to the CPU, e.g., in shared memory or by copying the parameter values from GPU memory to main memory. Block 318 returns the output of the GPU function code, e.g., as output parameters of the ExecuteComputation function, which then returns to its caller.

FIG. 4A is a flow diagram illustrating a scheduler process in accordance with embodiments of the invention. The scheduler process corresponds to the scheduler 114 of FIG. 1 and is, in one example, included in the operating system kernel 104 or other operating system module. The scheduler process is invoked when a thread is created, e.g., by a game application. Block 402 corresponds to such a thread creation operation. Block 404 receives a GPU code function and an optional thread priority from the user application, and stores the function for later use. The function may be stored in, for example, thread local memory storage associated with the thread. Block 406 creates a thread control block (TCB) that represents the thread, sets the TCB's attributes, including the thread priority and the GPU code function, and adds the TCB to the end of the ready queue 116. The thread is now ready to be scheduled and allocated to a processor by the dispatcher 118.

FIG. 4B is a flow diagram illustrating a dispatcher process in accordance with embodiments of the invention. The dispatcher process corresponds to the dispatcher 118 of FIG. 1 and is, in one example, included in the operating system kernel 104 or other operating system module. The dispatcher process is invoked when the scheduler is ready to select another thread for execution, which may be, for example, when a thread currently being executed by the CPU has requested an I/O operation, or has begun waiting for an event or signal, or when the currently executing thread's time slice has expired. Block 420 determines if the GPU is available, and if not, causes the thread to be allocated to the CPU at block 426. Otherwise, the process continues at block 422, which selects the highest priority TCB in the ready queue (this TCB corresponds to a thread referred to herein as the “selected thread”) and removes the selected TCB from the queue.

Block 424 selects a processor to allocate to the thread based on the priorities of the other threads, the priorities of the threads currently being executed by the processors, and/or the current utilization loads of the processors, as described above. Block 424 can also use attributes of the task to be executed, such as the type of the task, to select a processor for the thread. In one example, block 424 allocates the thread to the CPU if the next high priority thread in the ready queue is a GPU thread, and vice versa for allocation to the GPU. In another example, block 424 determines a weight value based the types of the threads in the ready queue, e.g., as the sum of the priorities of the CPU-only threads in the ready queue, and determines a weight value based on the CPU and GPU-compatible threads as the sum of the priorities of the CPU and GPU-compatible threads in the ready queue. (If some threads are compatible with the GPU but not the CPU, then a GPU-only sum can be used). Block 424 allocates the thread to the CPU if the sum of the CPU-only thread priorities is less than the sum of the GPU and CPU-compatible thread priorities, and vice versa for the GPU, based on the priorities of the CPU-only threads. In another example, block 424 uses a condition such as that shown in block 304 of FIG. 3 to allocate the thread to the processor having the least utilization. In other examples, block 424 may combine two or more of the foregoing conditions, e.g., by allocating a thread to the GPU if the next high-priority thread is a CPU-only thread and the GPU load is lower than the CPU load. Block 424 will not select an incompatible processor for the thread. For example, the GPU will not be selected for a CPU-only thread, and vice versa.

Block 426 allocates the thread to the CPU if the CPU was selected at block 424. Block 426 causes a context switch between the currently-executing thread and the selected thread. The thread executes on the CPU at block 428.

If block 425 determines that the GPU was selected at block 424, then block 442 allocates the selected thread to the GPU, and ensures that the GPU function code is loaded into the GPU as described above with respect to FIG. 3. Block 444 provides input parameter values to the GPU, invokes the GPU function, and receives output parameter values as described above with respect to blocks 308, and 314, and 318, respectively, of FIG. 3. Block 446 provides the output parameter values to the caller, e.g., by storing the values in the thread's local memory storage.

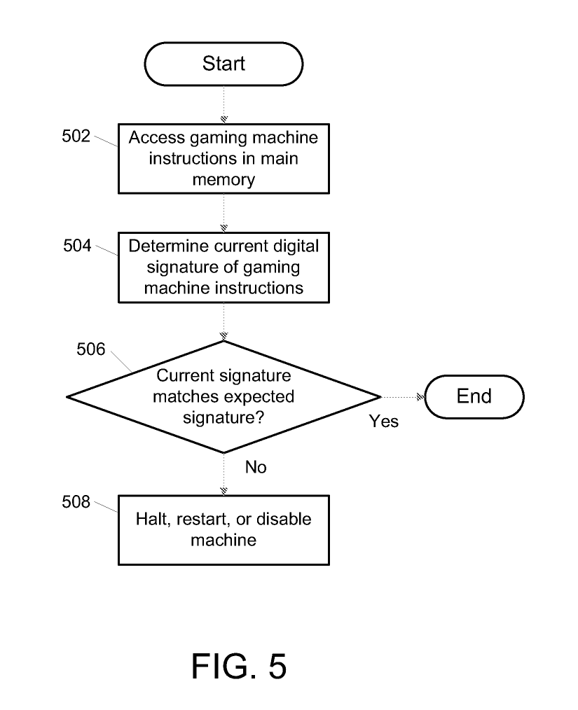

FIG. 5 is a flow diagram illustrating a process of authenticating game code in accordance with embodiments of the invention. The authentication process executes on the GPU 138 shown in FIG. 1 and begins at block 502 by accessing gaming machine instructions (e.g., the game application(s) and/or operating system code) in the main memory 102 of the game machine 100. The instructions are accessed directly in memory after the game machine has been initialized. The game instructions can be checked at any time, and unauthorized modification of the game instructions while the gaining machine is running can be detected. The accessing of the game instructions may be via shared memory or via the PCI Express bus 136, in which case the game instructions are copied from the main memory to GPU memory, where they can be accessed by the GPU. At block 504, the GPU determines a current digital signature of the game instructions by, for example, computing a secure hash code and/or digital signature of the memory area in which the game machine instructions are stored. Block 506 compares the current signature to a stored expected signature that is known to be correct for the game instructions. If the signatures are equal, the process exits with no further action. If the signatures are not equal, block 508 restarts or halts the gaming machine or takes other appropriate action. A complementary process can be provided in which the CPU accesses and verifies the GPU code in the GPU memory. Examples of authentication processes that may be executed on the GPU are described in U.S. Pat. No. 5,643,086 to Alcorn et al., entitled “ELECTRONIC CASINO GAMING APPARATUS WITH IMPROVED PLAY CAPACITY, AUTHENTICATION AND SECURITY” and filed on Jun. 29, 1995, U.S. Pat. No. 6,149,522 to Alcorn et al., entitled “METHOD OF AUTHENTICATING GAME DATA SETS IN AN ELECTRONIC CASINO GAMING SYSTEM” and filed on Jun. 29, 1998, and U.S. Pat. No. 7,043,641 to Martinek et al., entitled “ENCRYPTION IN A SECURE COMPUTERIZED GAMING SYSTEM” and filed on Mar. 8, 2000, all three of which are incorporated herein by reference in their entireties and for all purposes.

Turning next to FIG. 6, a video gaming machine 2 in accordance with embodiments of the invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a belly glass 40. Viewable through the main door is a video display monitor 34 and an information panel 36. The display monitor 34 will typically be a cathode ray tube, high resolution flat-panel LCD, or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 7, which sits on top of the main cabinet 4. The top box 7 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 7 may house different or additional devices than shown in FIG. 5. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines of the present assignee are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in IGT gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

IGT gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modern general-purpose computers include voltage monitoring circuitry, these types of circuits only report voltage status to the operating software. Out of tolerance voltages can cause software malfunction, creating a potential uncontrolled condition in the gaming computer. Gaming machines of the present assignee typically have power supplies with tighter voltage margins than that required by the operating circuitry. In addition, the voltage monitoring circuitry implemented in IGT gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for IGT slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as IGT gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, IGT's Netplex is a proprietary communication protocol used for serial communication between gaming devices. As another example, SAS is a communication protocol used to transmit information, such as metering information, from a gaming machine to a remote device. Often SAS is used in conjunction with a player tracking system.

IGT gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into an IGT gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in an IGT gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. Further details related to trusted memory devices that may be used in the present invention are described in U.S. Pat. No. 6,685,567 from U.S. patent application Ser. No. 09/925,098, filed Aug. 8, 2001, entitled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, IGT gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 5, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions that affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights behind the belly glass 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

Some networks described herein provide methods and devices for managing one or more networked gaming establishments. Such networks may sometimes be referred to herein as server-based gaming networks, sb™ networks, or the like. Some such gaming networks described herein allow for the convenient provisioning of networked gaming machines and other devices relevant to casino operations. Game themes may be easily and conveniently added or changed, if desired. Related software, including but not limited to player tracking software, peripheral software, etc., may be downloaded to networked gaming machines, mobile gaming devices, thin clients and/or other devices, such as kiosks, networked gaming tables, player stations, etc.

In some implementations, servers or other devices of a central system will determine game outcomes and/or provide other wager gaming functionality. In some such implementations, wagering games may be executed primarily on one or more devices of a central system, such as a server, a host computer, etc. For example, wager gaming determinations (such as interim and final game outcomes, bonuses, etc.) may be made by one or more servers or other networked devices. Player tracking functions, accounting functions and even some display-related functions associated with wagering games may be performed, at least in part, by one or more devices of casino network and/or of a central system.

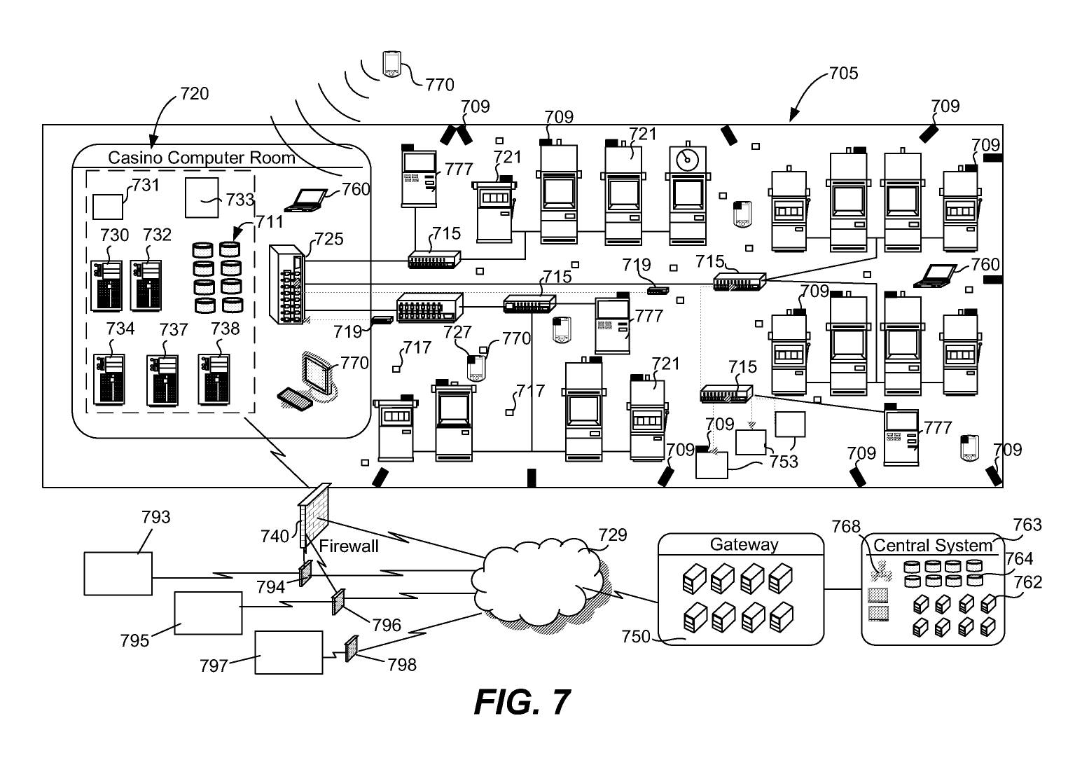

One example of an sb™ network is depicted in FIG. 7. Those of skill in the art will realize that this architecture and the related functionality are merely examples and that the present invention encompasses many other such embodiments and methods.

Here, casino computer room 720 and networked devices of a gaming establishment 705 are illustrated. Gaming establishment 705 is configured for communication with central system 763 via gateway 750. Gaming establishments 793 and 795 are also configured for communication with central system 763.

In some implementations, gaming establishments may be configured for communication with one another. In this example, gaming establishments 793 and 795 are configured for communication with casino computer room 720. Such a configuration may allow devices and/or operators in casino 705 to communicate with and/or control devices in other casinos. In some such implementations, a server in computer room 720 may control devices in casino 705 and devices in other gaming establishments. Conversely, devices and/or operators in another gaming establishment may communicate with and/or control devices in casino 705.

For example, a server of casino 705 or central system 763 may be provisioned with relatively more advanced software (e.g., 3-D facial recognition software) for patron identification than servers of other networked locations. Such a server may process patron identification requests from devices in casino 705 as well as patron identification requests from devices in gaming establishments 793 and 795.

Here, gaming establishment 797 is configured for communication with central system 763, but is not configured for communication with other gaming establishments. Some gaming establishments (not shown) may not be in communication with other gaming establishments or with a central system. Gaming establishment 705 includes multiple gaming machines 721, each of which is part of a bank 710 of gaming machines 721. In this example, gaming establishment 705 also includes a bank of networked gaming tables 753. However, the present invention may be implemented in gaming establishments having any number of gaming machines, gaming tables, etc. It will be appreciated that many gaming establishments include hundreds or even thousands of gaming machines 721 and/or gaming tables 753, not all of which are necessarily included in a bank and some of which may not be connected to a network. At least some of gaming machines 721 and/or mobile devices 770 may be “thin clients” that are configured to perform client-side methods as described elsewhere herein.

Some gaming networks provide features for gaming tables that are similar to those provided for gaming machines, including but not limited to bonusing, player loyalty/player tracking and the use of cashless instruments. Relevant material is provided in U.S. patent application Ser. No. 11/154,833, entitled “CASHLESS INSTRUMENT BASED TABLE GAME PROMOTIONAL SYSTEM AND METHODOLOGY” and filed on Jun. 15, 2005 (attorney docket no. IGT1P035X3), U.S. Provisional Patent Application No. 70/858,046, entitled “AUTOMATED PLAYER DATA COLLECTION SYSTEM FOR TABLE GAME ENVIRONMENTS” and filed on Nov. 10, 2006 (attorney docket no. IGT1P061X5P), U.S. patent application Ser. No. 11/129,702, entitled “WIDE AREA TABLE GAMING MONITOR AND CONTROL SYSTEM” and filed on May 15, 2005 (attorney docket no. IGT1P115), U.S. patent application Ser. No. 11/425,998 entitled “PROGRESSIVE TABLE GAME BONUSING SYSTEMS AND METHODS”, filed Jun. 22, 2006 (attorney docket no. IGT1P238/P-1049) and U.S. patent application Ser. No. 11/225,299, entitled “UNIVERSAL CASINO BONUSING SYSTEMS AND METHODS” and filed on Sep. 12, 2005 (attorney docket no. IGT1P243), all of which are incorporated herein by reference. Accordingly, software related to such features may be provided and/or controlled, and related data may be obtained and/or provided, according to the present invention.

Some configurations can provide automated, multi-player roulette, blackjack, baccarat, and other table games. The table games may be conducted by a dealer and/or by using some form of automation, which may include an automated roulette wheel, an electronic representation of a dealer, etc. In some such implementations, devices such as cameras, radio frequency identification devices, etc., may be used to identify and/or track playing cards, chips, etc. Some of gaming tables 753 may be configured for communication with individual player terminals (not shown), which may be configured to accept bets, present an electronic representation of a dealer, indicate game outcomes, etc.

Some gaming networks include electronically configurable tables for playing table games. U.S. patent application Ser. No. 11/517,861, entitled “CASINO DISPLAY METHODS AND DEVICES” and filed on Sep. 7, 2006 (attorney docket no. IGT1P106X2), describes some such tables and is hereby incorporated by reference. An operator may select a desired game, such as a poker game or a blackjack game, and the table will be automatically configured with geometrical patterns, text, etc., which are appropriate for the desired table game. The desired type of table game may be selected by a control on the table itself or according to instructions received from, e.g., a server or a casino manager via a network interface.

Gaming establishment 705 also includes networked kiosks 777. Depending on the implementation, kiosks 777 may be used for various purposes, including but not limited to cashing out, prize redemption, redeeming points from a player loyalty program, redeeming “cashless” indicia such as bonus tickets, smart cards, etc. In some implementations, kiosks 777 may be used for obtaining information about the gaming establishment, e.g., regarding scheduled events (such as tournaments, entertainment, etc.), regarding a patron's location, etc. Software related to such features may be provided and/or controlled, and related data may be obtained and/or provided, according to the present invention. For example, in some implementations of the invention, kiosks 777 may be configured to receive information from a patron, e.g., by presenting graphical user interfaces.

In this example, each bank 710 has a corresponding switch 715, which may be a conventional bank switch in some implementations. Each switch 715 is configured for communication with one or more devices in computer room 720 via main network device 725, which combines switching and routing functionality in this example. Although various communication protocols may be used, some preferred implementations use the Gaming Standards Association's G2S Message Protocol. Other implementations may use IGT's open, Ethernet-based SuperSAS® protocol, which IGT makes available for downloading without charge. Still other protocols, including but not limited to Best of Breed (“BOB”), may be used to implement various aspects of the invention. IGT has also developed a gaming-industry-specific transport layer called CASH that rides on top of TCP/IP and offers additional functionality and security.

Here, gaming establishment 705 also includes an RFID network, implemented in part by RFID switches 719 and multiple RFID readers 717. An RFID network may be used, for example, to track objects (such as mobile gaming devices 770, which include RFID tags 727 in this example), patrons, etc., in the vicinity of gaming establishment 705. Some examples of how an RFID network may be used in a gaming establishment are set forth in U.S. patent application Ser. No. 11/655,496, entitled “DYNAMIC CASINO TRACKING AND OPTIMIZATION” and filed on Jan. 19, 2007 (Attorney Docket No. IGT1P082C1X1/P-713 CON CIP) and in U.S. patent application Ser. No. 11/599,241, entitled “DOWNLOADING UPON THE OCCURRENCE OF PREDETERMINED EVENTS” and filed on Nov. 13, 2006 (Attorney Docket No. IGT1P118C1X1/P-303 CON CIP), all of which are hereby incorporated by reference.

As noted elsewhere herein, some implementations of the invention may involve “smart” player loyalty instruments, such as player tracking cards, which include an RFID tag. Accordingly, the location of such RFID-enabled player loyalty instruments may be tracked via the RFID network. In this example, at least some of mobile devices 770 may include an RFID tag 727, which includes encoded identification information for the mobile device 770. Accordingly, the locations of such tagged mobile devices 770 may be tracked via the RFID network in gaming establishment 705. Other location-detection devices and systems, such as the global positioning system (“GPS”), may be used to monitor the location of people and/or devices in the vicinity of gaming establishment 705 or elsewhere.

Various alternative network topologies can be used to implement different aspects of the invention and/or to accommodate varying numbers of networked devices. For example, gaming establishments with large numbers of gaming machines 721 may require multiple instances of some network devices (e.g., of main network device 725, which combines switching and routing functionality in this example) and/or the inclusion of other network devices not shown in FIG. 7. Some implementations of the invention may include one or more middleware servers disposed between kiosks 777, RFID switches 719 and/or bank switches 715 and one or more devices in computer room 720 (e.g., a corresponding server). Such middleware servers can provide various useful functions, including but not limited to the filtering and/or aggregation of data received from switches, from individual gaming machines and from other devices. Some implementations of the invention include load-balancing methods and devices for managing network traffic.

Storage devices 711, sb™ server 730, License Manager 731, Arbiter 733, servers 732, 734, 736 and 738, host device(s) 760 and main network device 725 are disposed within computer room 720 of gaming establishment 705. In practice, more or fewer devices may be used. Depending on the implementation, some such devices may reside in gaming establishment 705 or elsewhere.

One or more devices in central system 763 may also be configured to perform, at least in part, tasks specific to the present invention. For example, one or more servers 762, arbiter 733, storage devices 764 and/or host devices 760 of central system 763 may be configured to implement the functions described in detail elsewhere herein. These functions may include, but are not limited to, processing requests for motion control profiles, providing (at least in part) motion control profiles to gaming machines, providing motion control code and transfer code to gaming machines, and so on.

One or more of the servers of computer room 720 may be configured with software for receiving a player's wager gaming notification parameters, determining when a wagering condition corresponds with the wager gaming notification parameters and/or providing a notification to the player when the wagering condition corresponds with the wager gaming notification parameters. Moreover, one or more of the servers may be configured to receive, process and/or provide image data from cameras 709, to provide navigation data to patrons (e.g., to indicate the location of and/or directions to a gaming table, a wager gaming machine, etc., associated with a wager gaming notification), etc.

For example, navigation data (which may include map data, casino layout data, camera image data, etc.) may be provided by one or more of the servers of computer room 720 to mobile devices 770. Some implementations of the present invention include a plurality of networked cameras 709, which may be video cameras, smart cameras, digital still cameras, etc. In some such implementations, such cameras may provide, at least in part, real-time navigation features such as those described in U.S. patent application Ser. No. 12/106,771 (attorney docket no. IGT1P410/P-1222), entitled “Real-Time Navigation Devices, Systems and Methods,” which is incorporated herein by reference.

Other devices that may be deployed in network 705 do not appear in FIG. 7. For example, some gaming networks may include not only various radio frequency identification (“RFID”) readers 717, but also RFID switches, middleware servers, etc., some of which are not depicted in FIG. 7. These features may provide various functions. For example, a server (or another device) may determine a location of a mobile device 770 according to the location of an RFID reader that reads an RFID tag 727.

The servers and other devices indicated in FIG. 7 may be configured for communication with other devices in or outside of gaming establishment 705, such as host devices 760, kiosks 777 and/or mobile devices 770, for implementing some methods described elsewhere herein. Servers (or the like) may facilitate communications with such devices, receive and store patron data, provide appropriate responses, etc., as described elsewhere herein.

Some of these servers may be configured to perform tasks relating to accounting, player loyalty, bonusing/progressives, configuration of gaming machines, etc. One or more such devices may be used to implement a casino management system, such as the IGT Advantage™ Casino System suite of applications, which provides instantaneous information that may be used for decision-making by casino managers. A Radius server and/or a DHCP server may also be configured for communication with the gaming network. Some implementations of the invention provide one or more of these servers in the form of blade servers.

Some preferred embodiments of sb™ server 730 and the other servers shown in FIG. 7 include (or are at least in communication with) clustered CPUs, redundant storage devices, including backup storage devices, switches, etc. Such storage devices may include a “RAID” (originally redundant array of inexpensive disks, now also known as redundant array of independent disks) array, back-up hard drives and/or tape drives, etc.

In some implementations of the invention, many of these devices (including but not limited to License Manager 731, servers 732, 734, 736 and 738, and main network device 725) are mounted in a single rack with sb™ server 730. Accordingly, many or all such devices will sometimes be referenced in the aggregate as an “sb™ server.” However, in alternative implementations, one or more of these devices is in communication with sb™ server 730 and/or other devices of the network but located elsewhere. For example, some of the devices could be mounted in separate racks within computer room 720 or located elsewhere on the network. Moreover, it can be advantageous to store large volumes of data elsewhere via a storage area network (“SAN”).

Computer room 720 may include one or more operator consoles or other host devices that are configured for communication with other devices within and outside of computer room 720. Such host devices may be provided with software, hardware and/or firmware for implementing various aspects of the invention. However, such host devices need not be located within computer room 720. Wired host devices 760 (which are desktop and laptop computers in this example) and wireless devices 770 (which are PDAs in this example) may be located elsewhere in gaming establishment 705 or at a remote location.

Some embodiments of the invention include devices for implementing access control, security and/or other functions relating to the communication between different devices on the network. In this example, arbiter 733 serves as an intermediary between different devices on the network. Arbiter 733 may be implemented, for example, via software that is running on a server or another networked device. Some implementations of Arbiter 733 are described in U.S. patent application Ser. No. 10/948,387, entitled “METHODS AND APPARATUS FOR NEGOTIATING COMMUNICATIONS WITHIN A GAMING NETWORK” and filed Sep. 23, 2004 (the “Arbiter Application”), which is incorporated herein by reference and for all purposes. In some preferred implementations, Arbiter 733 is a repository for the configuration information required for communication between devices on the gaming network (and, in some implementations, devices outside the gaming network). Although Arbiter 733 can be implemented in various ways, one example implementation is discussed in the following paragraphs.

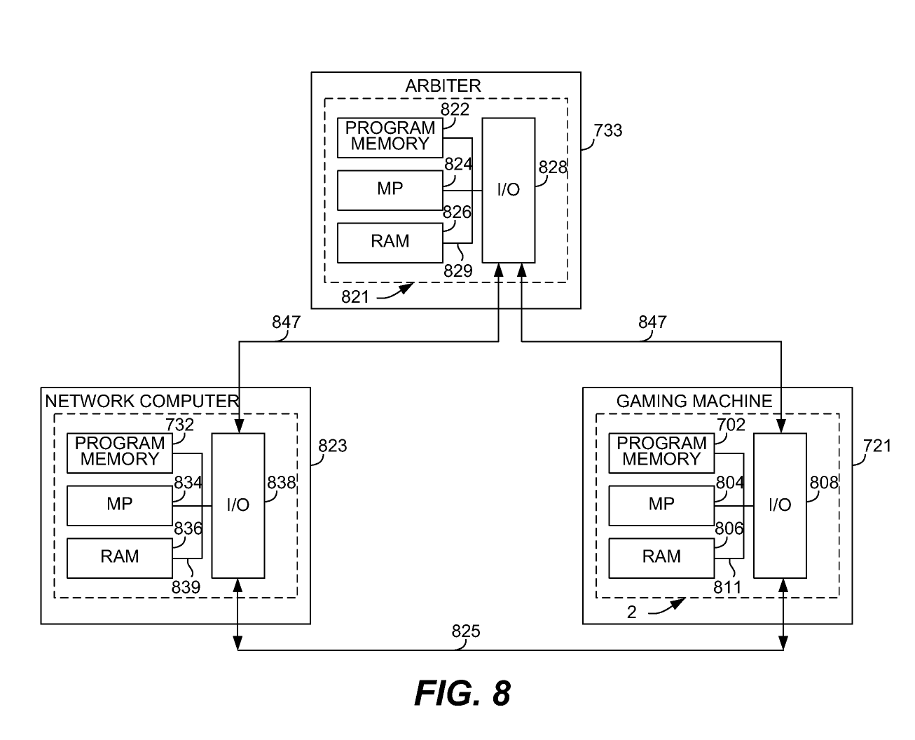

FIG. 8 is a block diagram of a simplified communication topology between gaming machine 721, network computer 823 and Arbiter 733. Network computer 823 may be, for example, a server or other device within computer room 720 or elsewhere. Although only one gaming machine 721, one network computer 823 and one Arbiter 733 are shown in FIG. 8, it should be understood that the following examples may be applicable to different types of networked devices in addition to gaming machine 721 and network computer 823, and may include different numbers of network computers 823, Arbiters 733 and gaming machines 721. For example, a single Arbiter 733 may be used for secure communications among a plurality of network computers 823 and tens, hundreds or thousands of gaming machines 721. Likewise, multiple Arbiters 733 may be utilized for improved performance and other scalability factors.

Referring to FIG. 8, the Arbiter 733 may include an arbiter controller 821 that may comprise a program memory 822, a microcontroller or microprocessor (MP) 824, a random-access memory (RAM) 826 and an input/output (I/O) circuit 828, all of which may be interconnected via an address/data bus 829. The network computer 823 may also include a controller 831 that may comprise a program memory 832, a microcontroller or microprocessor (MP) 834, a random-access memory (RAM) 836 and an input/output (I/O) circuit 838, all of which may be interconnected via an address/data bus 839. It should be appreciated that although the Arbiter 733 and the network computer 823 are each shown with only one microprocessor 824, 834, the controllers 821, 831 may each include multiple microprocessors 824, 834. Similarly, the memory of the controllers 821, 831 may include multiple RAMs 826, 836 and multiple program memories 822, 832. Although the I/O circuits 828, 838 are each shown as a single block, it should be appreciated that the I/O circuits 828, 838 may include a number of different types of I/O circuits. The RAMs 824, 834 and program memories 822, 832 may be implemented as semiconductor memories, magnetically readable memories, and/or optically readable memories, for example.

Although the program memories 822, 832 are shown in FIG. 8 as read-only memories (ROM) 822, 832, the program memories of the controllers 821, 831 may be a read/write or alterable memory, such as a hard disk. In the event a hard disk is used as a program memory, the address/data buses 829, 839 shown schematically in FIG. 8 may each comprise multiple address/data buses, which may be of different types, and there may be an I/O circuit disposed between the address/data buses.

As shown in FIG. 8, the gaming machine 721 may be operatively coupled to the network computer 823 via the data link 825. The gaming machine 721 may also be operatively coupled to the Arbiter 733 via the data link 849, and the network computer 823 may likewise be operatively coupled to the Arbiter 733 via the data link 847.

Communications between the gaming machine 721 and the network computer 823 may involve different information types of varying levels of sensitivity resulting in varying levels of encryption techniques depending on the sensitivity of the information. For example, communications such as drink orders and statistical information may be considered less sensitive. A drink order or statistical information may remain encrypted, although with moderately secure encryption techniques, such as RC4, resulting in less processing power and less time for encryption. On the other hand, financial information (e.g., account information, winnings, etc.), download information (e.g., game and/or peripheral software, licensing information, etc.) and personal information (e.g., social security number, personal preferences, etc.) may be encrypted with stronger encryption techniques such as DES or 3DES to provide increased security.

As disclosed in further detail in the Arbiter Application, the Arbiter 733 may verify the authenticity of devices in the gaming network, including but not limited to devices sending queries and/or remote procedure calls to gaming machines. The Arbiter 733 may receive a request for a communication session from a network device. For ease of explanation, the requesting network device may be referred to as the client, and the requested network device may be referred to as the host. The client may be any device on the network and the request may be for a communication session with any other network device. The client may specify the host, or the gaming security arbiter may select the host based on the request and based on information about the client and potential hosts. The Arbiter 733 may provide encryption keys (session keys) for the communication session to the client via the secure communication channel. Either the host and/or the session key may be provided in response to the request, or may have been previously provided. The client may contact the host to initiate the communication session. The host may then contact the Arbiter 733 to determine the authenticity of the client. The Arbiter 733 may provide affirmation (or lack thereof) of the authenticity of the client to the host and provide a corresponding session key, in response to which the network devices may initiate the communication session directly with each other using the session keys to encrypt and decrypt messages.

Alternatively, upon receiving a request for a communication session, the Arbiter 733 may contact the host regarding the request and provide corresponding session keys to both the client and the host. The Arbiter 733 may then initiate either the client or the host to begin their communication session. In turn, the client and host may begin the communication session directly with each other using the session keys to encrypt and decrypt messages. An additional explanation of the communication request, communication response and key distribution is provided in the Arbiter Application.

Referring again to FIG. 7, the communication link(s) between casino 705 and central system 763 preferably have ample bandwidth and may, for example, comprise one or more T1 or T3 connections and/or satellite links having comparable bandwidth, etc. Network 729 is the Internet in this example. However, it will be understood by those of skill in the art that network 729 could include any one of various types of networks, such as the public switched telephone network (“PSTN”), a satellite network, a wireless network, a metro optical transport, etc. Accordingly, a variety of protocols may be used for communication on network 729, such as Internet Protocol (“IP”), Fibre Channel (“FC”), FC over IP (“FCIP”), Internet SCSI (“iSCSI,” an IP-based standard for linking data storage devices over a network and transferring data by carrying SCSI commands over IP networks) or Dense Wavelength Division Multiplexing (“DWDM,” an optical technology used to increase bandwidth over existing fiber optic backbones).

If a host device is located in a remote location, security methods and devices (such as firewalls, authentication and/or encryption) should be deployed in order to prevent the unauthorized access of the gaming network.

Similarly, any other connection between gaming network 705 and the outside world should only be made with trusted devices via a secure link, e.g., via a virtual private network (“VPN”) tunnel. For example, the illustrated connection between sb™ server 730, gateway 750 and central system 763 (that may be used for communications involving peripheral device software downloads, etc.) is advantageously made via a VPN tunnel. Details of VPN methods that may be used with the present invention are described in the reference, “Virtual Private Networks-Technologies and Solutions,” by R. Yueh and T. Strayer, Addison-Wesley, 2001, ISBN#0-201-70209-6, which is incorporated herein by reference and for all purposes. Additionally VPNs may be implemented using a variety of protocols, such as, for example, IP Security (IPSec) Protocol, Layer 2 Tunneling Protocol, Multiprotocol Label Switching (MPLS) Protocol, etc. Details of these protocols, including RFC reports, may be obtained from the VPN Consortium, an industry trade group (http://www.vpnc.com, VPNC, Santa Cruz, Calif.).

Alternatively, a permanent virtual circuit (“PVC”) can be established to provide a dedicated and secure circuit link between two facilities, e.g., between a casino and central system 763. A PVC is a virtual circuit established for repeated use between the same data terminals. A PVC could be provided, for example, via AT&T's Asynchronous Transfer Mode (“ATM”) switching fabric. Some implementations provide a dedicated line from an endpoint (e.g., from casino 705) into the ATM backbone. Other implementations provide a connection over another network (e.g., the Internet) between an endpoint and the nearest device of the ATM backbone, e.g., to the nearest edge router. In some such implementations, the fixed-sized cells used in the ATM switching fabric may be encapsulated in variable sized packets (such as Internet Protocol or Ethernet packets) for transmission to and from the ATM backbone.

For security purposes, information transmitted to, on or from a gaming establishment may be encrypted. In one implementation, the information may be symmetrically encrypted using a symmetric encryption key, where the symmetric encryption key is asymmetrically encrypted using a private key. The public key may, for example, be obtained from a remote public key server. The encryption algorithm may reside in processor logic stored on the gaming machine. When a remote server receives a message containing the encrypted data, the symmetric encryption key is decrypted with a private key residing on the remote server and the symmetrically encrypted information sent from the gaming machine is decrypted using the symmetric encryption key. A different symmetric encryption key is used for each transaction where the key is randomly generated. Symmetric encryption and decryption is preferably applied to most information because symmetric encryption algorithms tend to be 100-10,000 faster than asymmetric encryption algorithms.

Some network implementations may use Trusted Network Connect (“TNC”), which is an open architecture provided by the Trusted Network Connect Sub Group (“TNC-SG”) of the Trusted Computing Group (TCG). TNC enables network operators to provide endpoint integrity at every network connection, thus enabling interoperability among multi-vendor network endpoints. Alternatively, or additionally, the Secure Internet File Transfer (“SIFT”) may be employed. SIFT allows devices to send and receive data over the Internet in a secure (128-bit encryption) method of transport.

Providing secure connections between devices in a gaming network, such as the connections between the local devices of the gaming network 705 and central system 763, allows for the deployment of many advantageous features. For example, a customer (e.g., an employee of a gaming establishment) may be able to log onto an account of central system 763 to obtain the account information such as the customer's current and prior account status. Automatic updates of a customer's software may also be enabled. For example, central system 763 may notify one or more devices in gaming establishment 705 regarding new products and/or product updates. For example, central system 763 may notify server (or other device) in computer room 720 regarding new software, software updates, the status of current software licenses, etc. Alternatively, such updates could be automatically provided to a server in computer room 720 and downloaded to networked gaming machines.

After the local server receives this information, relevant products of interest may be identified (by the server, by another device or by a human being). If an update or a new software product is desired, it can be downloaded from the central system. Similarly, a customer may choose to renew a software license via a secure connection with central system 763, e.g., in response to a notification that the software license is required.

In addition, providing secure connections between different gaming establishments can enable alternative implementations of the invention. For example, a number of gaming establishments may be owned and/or controlled by the same entity. In such situations, having secure communications between gaming establishments makes it possible for a gaming entity to use one or more servers in a gaming establishment as an interface between central system 763 and gaming machines in multiple gaming establishments. For example, new or updated software may be obtained by a server in one gaming establishment and distributed to gaming machines in that gaming establishment and/or other gaming establishments. A server in one gaming establishment may perform services, such as patron identification services, in response to a request from a device in another gaming establishment.

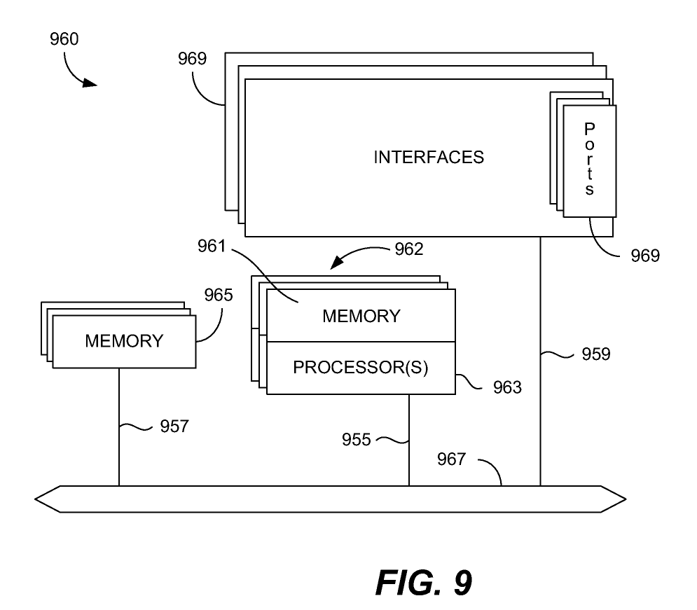

FIG. 9 illustrates an example of a network device that may be configured for implementing some methods of the present invention. Network device 960 includes a master central processing unit (CPU) 962, interfaces 968, and a bus 967 (e.g., a PCI bus). Generally, interfaces 968 include ports 969 appropriate for communication with the appropriate media. In some embodiments, one or more of interfaces 968 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 968 control such communications-intensive tasks as encryption, decryption, compression, decompression, packetization, media control and management. By providing separate processors for the communications-intensive tasks, interfaces 968 allow the master microprocessor 962 efficiently to perform other functions such as routing computations, network diagnostics, security functions, etc.

The interfaces 968 are typically provided as interface cards (sometimes referred to as “linecards”). Generally, interfaces 968 control the sending and receiving of data packets over the network and sometimes support other peripherals used with the network device 960. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 962 may be responsible for implementing specific functions associated with the functions of a desired network device. According to some embodiments, CPU 962 accomplishes all these functions under the control of software including an operating system and any appropriate applications software.

CPU 962 may include one or more processors 963 such as a processor from the Motorola family of microprocessors or the MIPS family of microprocessors. In an alternative embodiment, processor 963 is specially designed hardware for controlling the operations of network device 960. In a specific embodiment, a memory 961 (such as non-volatile RAM and/or ROM) also forms part of CPU 962. However, there are many different ways in which memory could be coupled to the system. Memory block 961 may be used for a variety of purposes such as, for example, caching and/or storing data, programming instructions, etc.

Regardless of network device's configuration, it may employ one or more memories or memory modules (such as, for example, memory block 965) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 9 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 9) or switch fabric based (such as a cross-bar).

The above-described devices and materials will be familiar to those of skill in the gaming industry and/or in the computer hardware and software arts. Although many of the components and processes are described above in the singular for convenience, it will be appreciated by one of skill in the art that multiple components and repeated processes can also be used to practice the techniques of the present invention.

Although illustrative embodiments and applications of this invention are shown and described herein, many variations and modifications are possible which remain within the concept, scope, and spirit of the invention, and these variations should become clear after perusal of this application. Accordingly, the present embodiments are to be considered as illustrative and not restrictive, and the invention is not to be limited to the details given herein, but may be modified within the scope and equivalents of the appended claims.

What is claimed is:

1. A wager gaming machine, comprising:
a value input system configured to receive indicia of credit;
a payout system configured to dispense indicia of credit;
a user input system configured to receive user input;
an interface system comprising at least one network interface;
a display system comprising at least one display device;
a graphics processing unit (“GPU”), configured to perform graphics processing tasks to control, at least in part, the display system;
a central processing unit (“CPU”) comprising at least one central processor, the CPU configured to do the following:
control the wager gaming machine to provide at least one wagering game;
make a delegation determination regarding when to delegate a non-graphics processing task to the GPU; and
send delegation instructions to the GPU after making the delegation determination,
wherein the GPU is further configured to receive the delegation instructions from the CPU and to perform the non-graphics processing task according to the delegation instructions.

2. The wager gaming machine of claim 1, wherein the CPU is further configured to make the delegation determination by comparing a CPU load average to a GPU load average, and to determine that the delegation instructions are to be sent to the GPU if the GPU's load average is less than the CPU's load average.

3. The wager gaming machine of claim 1, wherein the CPU is further configured to make the delegation determination when a thread of code is to be selected for execution by an operating system, and the delegation determination is made by the operating system based upon tasks available to run, tasks running on the CPU and GPU, and at least one attribute of the non-graphics processing task.

4. The wager gaming machine of claim 1, wherein the CPU is further configured to determine that the delegation instructions are to be sent to the GPU when the non-graphics processing task is a compute-intensive task.

5. The wager gaming machine of claim 1, wherein the delegation instructions comprise instructions to:
load GPU-compatible code for the non-graphics processing task into the GPU;
cause the GPU to execute the GPU-compatible code for the non-graphics processing task;
receive a result of the non-graphics processing task; and
provide the result to the CPU.

6. The wager gaming machine of claim 1, wherein the non-graphics processing task comprises a communication task, a security related task, a compute-intensive task, or a combination thereof.

7. The wager gaming machine of claim 6, wherein the communication task comprises:
receiving data via the interface system;
parsing the data;
forming a data structure according to the parsing step; and
sending the data structure to the CPU.

8. The wager gaming machine of claim 6, wherein the communication task comprises:
receiving data from the CPU;
constructing a formatted message according to the data received from the CPU; and
transmitting the formatted message via the interface system.

9. The wager gaming machine of claim 6, wherein the communication task comprises:
receiving data via the interface system;
decrypting the data; and
sending decrypted data to the CPU.

10. The wager gaming machine of claim 6, wherein the communication task comprises:
receiving data from the CPU;
encrypting the data; and
transmitting encrypted data via the interface system.

11. The wager gaming machine of claim 6, wherein the security related task comprises an authentication task.

12. The wager gaming machine of claim 1, wherein the non-graphics processing task comprises:
receiving metering data from at least one of the value input system, the payout system, or the user input system; and
transmitting, via the interface system, the metering data.

13. The wager gaming machine of claim 1, wherein the CPU is further configured to provide the delegation instructions to the GPU via a common memory accessible by both the GPU and the CPU, the delegation instructions comprising:
accessing gaming machine instructions stored in the common memory;
determining if the gaming machine instructions have been altered; and
providing the result of determining if the gaming machine instructions have been altered to the CPU,
wherein the CPU is further configured to halt, suspend, or restart the wagering game when the gaming machine instructions have been altered.

14. The wager gaming machine of claim 13, wherein determining if the gaming machine instructions have been altered comprises:
determining a present digital signature based upon the gaming machine instructions; and
comparing the present digital signature to a predetermined digital signature that is based upon predetermined gaming machine instructions,
wherein the CPU is further configured to restart or halt the wager gaming machine when the present digital signature does not match the predetermined digital signature.

15. The wager gaming machine of claim 13, wherein the gaming machine instructions are received from an executable code image associated with an operating system process.

16. The wager gaming machine of claim 13, wherein the common memory is the CPU's main memory.

17. The wager gaming machine of claim 1, wherein the CPU is further configured to do the following:
access the delegation instructions via a common memory accessible by both the GPU and the CPU;
determine if the delegation instructions have been altered; and
restart or halt the wager gaming machine when the delegation instructions have been altered.

18. The wager gaming machine of claim 17, wherein the CPU is further configured to:
determine a present digital signature based upon the delegation instructions;
compare the present digital signature to a predetermined digital signature; and
restart or halt the wager gaming machine when the present digital signature does not match the predetermined digital signature.

19. The wager gaming machine of claim 6, wherein the security related task comprises monitoring access to the wager gaming machine.

20. The wager gaming machine of claim 7, wherein the data structure can be processed more efficiently by the CPU than the data received via the interface system.

21. The wager gaming machine of claim 7, wherein the data received via the interface system is represented in Extensible Markup Language (“XML”) format.

22. The wager gaming machine of claim 7, wherein the data received via the interface system is represented in Game to System (“G2S”) format.

23. The wager gaming machine of claim 1, further comprising a removable graphics card, wherein the GPU is located on the removable graphics card.

24. The wager gaming machine of claim 1, further comprising a main processor board, wherein the GPU and the CPU are located on the main processor board.

25. A wager gaming machine, comprising:
a value input system configured to receive indicia of credit;
a payout system configured to dispense indicia of credit;
a user input system configured to receive user input;
an interface system comprising at least one network interface;
a display system comprising at least one display device;
a central processing unit (“CPU”) comprising at least one central processor, the CPU configured to do the following, in accordance with gaming machine instructions:
control the wager gaming machine to provide at least one wagering game;
a graphics processing unit (“GPU”) configured to perform graphics processing tasks to control, at least in part, the display system,
wherein the GPU is configured to receive delegation instructions from a memory device associated with the GPU, the delegation instructions comprising:
accessing gaming machine instructions from a memory device associated with the CPU;
determining if the gaming machine instructions have been altered; and
halting, suspending, or restarting the gaming machine when the gaming machine instructions have been altered.

26. The wager gaming machine of claim 25, wherein determining if the gaming machine instructions have been altered comprises:
determining a present digital signature based upon the gaming machine instructions; and
comparing the present digital signature to a predetermined digital signature that is based upon predetermined gaming machine instructions,
wherein the GPU is configured to halt, suspend, or restart the wager gaming machine when the present digital signature does not match the predetermined digital signature.

27. The wager gaming machine of claim 25, wherein the memory device associated with the GPU comprises a read-only memory.

28. The wager gaming machine of claim 25, wherein the CPU is further configured to:
make a delegation determination regarding when to delegate a non-graphics processing task to the GPU; and
send delegation instructions to the GPU after making a corresponding delegation determination,
wherein the GPU is further configured to receive delegation instructions from the CPU and to perform the non-graphics processing task according to the delegation instructions.

29. The wager gaming machine of claim 25, further comprising a removable graphics card, wherein the GPU is located on the removable graphics card.

30. The wager gaming machine of claim 25, further comprising a main processor board, wherein the GPU and the CPU are located on the main processor board.

31. A non-transitory computer-readable medium having stored thereon stored instructions that, when executed by a central processing unit (“CPU”) of a gaming machine, direct the CPU to:
determine whether to delegate a non-graphics processing task to a graphics processing unit (“GPU”), wherein the GPU is separate from the CPU; and
send delegation instructions to the GPU in response to determining that the non-graphics processing task is to be delegated to the GPU,
wherein the delegation instructions are configured to perform the non-graphics processing task, and
the GPU is configured to receive the delegation instructions from the CPU and to perform the non-graphics processing task according to the delegation instructions.

32. The computer-readable medium of claim 31, wherein the stored instructions to determine whether to delegate a non-graphics processing task to a GPU further direct the CPU to:
compare a CPU load measurement to a GPU load measurement; and
determine that the delegation instructions are to be sent to the GPU if the GPU load measurement is less than the CPU load measurement.

33. The computer-readable medium of claim 31, wherein the stored instructions to determine whether to delegate a non-graphics processing task to a GPU further direct the CPU to select a next task to execute based upon tasks available to run, tasks running on the CPU and GPU, and at least one attribute of the non-graphics processing task.

34. The computer-readable medium of claim 31, wherein the stored instructions to determine whether to delegate a non-graphics processing task to a GPU further direct the CPU to determine that the delegation instructions are to be sent to the GPU when the non-graphics processing task is a compute-intensive task.

35. The computer-readable medium of claim 31, wherein the delegation instructions, when executed by the GPU, direct the GPU to:
load GPU-compatible code for the non-graphics processing task into the GPU;
cause the GPU to execute the GPU-compatible code for the non-graphics processing task;
receive a result of the non-graphics processing task; and
provide the result to the CPU.

36. The computer-readable medium of claim 31, wherein the non-graphics processing task comprises a communication task, a security related task, a compute-intensive task, or a combination thereof.

37. The computer-readable medium of claim 36, wherein the communication task comprises:
receiving data via the interface system;
parsing the data;
forming a data structure according to the parsing step; and
sending the data structure to the CPU.

38. The computer-readable medium of claim 36, wherein the communication task comprises:
receiving data from the CPU;
constructing a formatted message according to the data received from the CPU; and
transmitting the formatted message via the interface system.

39. The computer-readable medium of claim 36, wherein the communication task comprises:
receiving data via the interface system;
decrypting the data; and
sending decrypted data to the CPU.

40. The computer-readable medium of claim 36, wherein the communication task comprises:
receiving data from the CPU;
encrypting the data; and
transmitting encrypted data via the interface system.

41. The computer-readable medium of claim 36, wherein the security related task comprises an authentication task.

42. The computer-readable medium of claim 31, wherein the non-graphics processing task comprises:
receiving metering data from at least one of the value input system, the payout system or the user input system; and
transmitting, via the interface system, the metering data.

43. The computer-readable medium of claim 31, wherein the stored instructions further direct the CPU to provide the delegation instructions to the GPU via a common memory accessible by both the GPU and the CPU, and the delegation instructions, when executed by the GPU, direct the GPU to:
access gaming machine instructions stored in the common memory;
determine if the gaming machine instructions have been altered; and
provide the result of determining if the gaming machine instructions have been altered to the CPU,
wherein the stored instructions further direct the CPU to halt, suspend, or restart the wagering game when the gaming machine instructions have been altered.

44. The computer-readable medium of claim 43, wherein the delegation instructions, when executed by the GPU, further direct the GPU to:
determine a present digital signature based upon the gaming machine instructions; and
compare the present digital signature to a predetermined digital signature that is based upon predetermined gaming machine instructions,
wherein the stored instructions, when executed by the CPU, further direct the CPU to restart or halt the wager gaming machine when the present digital signature does not match the predetermined digital signature.

45. The computer-readable medium of claim 43, wherein the gaming machine instructions are received from an executable code image associated with an operating system process.

46. The computer-readable medium of claim 43, wherein the common memory is the CPU's main memory.

47. The computer-readable medium of claim 31, wherein the stored instructions, when executed by the CPU, further direct the CPU to:
access the delegation instructions via a common memory accessible by both the GPU and the CPU;
determine if the delegation instructions have been altered; and
restart or halt the wager gaming machine when the delegation instructions have been altered.

48. The computer-readable medium of claim 47, wherein the stored instructions, when executed by the CPU, further direct the CPU to:
determine a present digital signature based upon the delegation instructions;
compare the present digital signature to a predetermined digital signature; and
restart or halt the wager gaming machine when the present digital signature does not match the predetermined digital signature.

49. The computer-readable medium of claim 36, wherein the security related task comprises monitoring access to the wager gaming machine.

50. The computer-readable medium of claim 37, wherein the data structure is processed more efficiently by the CPU than the data received via the interface system.

51. The computer-readable medium of claim 37, wherein the data received via the interface system is represented in Extensible Markup Language (“XML”) format.

52. The computer-readable medium of claim 37, wherein the data received via the interface system is represented in Game to System (“G2S”) format.

53. A non-transitory computer-readable medium having stored thereon stored instructions that, when executed by a central processing unit (“CPU””) of a gaming machine, direct the CPU to:
control the wager gaming machine to provide at least one wagering game,
wherein the GPU is configured to receive the delegation instructions from a memory device associated with the GPU, the delegation instructions comprising instructions to:
access gaming machine instructions from the CPU's memory;
determine if the gaming machine instructions have been altered; and
halt, suspend, or restart the gaming machine when the gaming machine instructions have been altered.

54. The computer readable medium of claim 53, wherein the stored instructions further direct the CPU to:
determine a present digital signature based upon the gaming machine instructions;
compare the present digital signature to a predetermined digital signature that is based upon predetermined gaming machine instructions; and
halt, suspend, or restart the wager gaming machine when the present digital signature does not match the predetermined digital signature.

55. The computer readable medium of claim 53, wherein the memory device associated with the GPU comprises a read-only memory.

56. The computer readable medium of claim 53, wherein the stored instructions further direct the CPU to:
make a delegation determination regarding when to delegate a non-graphics processing task to the GPU; and
send delegation instructions to the GPU after making the delegation determination,
wherein the GPU is further configured to receive delegation instructions from the CPU and to perform the non-graphics processing task according to the delegation instructions.
